(19) United States
(12) Patent Application Publication
(10) Pub. No.: US 2023/0089225 A1
(43) Pub. Date: Mar. 23, 2023

(54) AUDIO RENDERING METHOD AND APPARATUS

(71) Applicant: Huawei Technologies Co., Ltd., Shenzhen (CN)

(72) Inventors: Bin WANG, Shenzhen (CN); Cal ARMSTRONG, Yorkshire (GB); Gavin KEARNEY, Yorkshire (GB); Yuan GAO, Beijing (CN)

(21) Appl. No.: 18/059,025

(22) Filed: Nov. 28, 2022

Related U.S. Application Data
(63) Continuation of application No. PCT/CN2021/080450, filed on Mar. 12, 2021.

(30) Foreign Application Priority Data
May 29, 2020 (CN) 202010480042.5

(51) Int. Cl. H04S 7/00; H04R 3/04; G10L 19/008; H04S 3/00

(52) U.S. Cl. CPC H04S 7/304; H04R 3/04; G10L 19/008; H04S 3/008; H04S 2420/01; H04S 2400/11; H04S 2400/01; H04S 2420/07

(57) ABSTRACT

This application discloses an audio rendering method and apparatus. The method includes: obtaining a to-be-rendered audio signal; determining K first combined HRTFS based on K first HRTFs and K second HRTFs; determining K second combined HRTFs based on K third HRTFs and K fourth HRTFs; determining a first target rendered signal based on the K first combined HRTFs and the to-be-rendered audio signal, where the first target rendered signal is a rendered signal output to the left ear of a listener; and determining a second target rendered signal based on the K second combined HRTFs and the to-be-rendered audio signal, where the second target rendered signal is a rendered signal output to the right ear of the listener.

### CROSS-REFERENCE TO RELATED APPLICATIONS

This application is a continuation of International Application No. PCT/CN2021/080450, filed on Mar. 12, 2021, which claims priority to Chinese Patent Application No. 202010480042.5, filed on May 29, 2020. The disclosures of the aforementioned applications are hereby incorporated by reference in their entireties.

### TECHNICAL FIELD

This application relates to the audio signal processing field, and in particular, to an audio rendering method and apparatus.

### BACKGROUND

With rapid development of high-performance computers and signal processing technologies, people raise increasingly high requirements for voice and audio experience. Immersive audio can meet people's requirements for the voice and audio experience. For example, 4th generation mobile communication technology (4G)/5th generation mobile communication technology (5G) communication voice, and video and audio technologies such as virtual reality (VR), augmented reality (AR), and mixed reality (MR) are gaining popularity. An immersive virtual reality system requires not only stunning visual effect but also realistic auditory effect. An audio-visual combination can greatly improve immersive experience of the virtual reality system.

A core of audio is a three-dimensional audio technology. Currently, there are mainly two replay manners for implementing three-dimensional audio: speaker-based replay and headphone-based replay. Currently, headphone-based binaural replay is commonly used in existing audio and video devices. However, how to improve auditory effect of headphone-based binaural replay of three-dimensional audio is an urgent technical problem to be resolved.

### SUMMARY

This application provides an audio rendering method and apparatus, to improve accuracy of sound image localization performed based on a binaural rendered signal, reduce in-head effect of the binaural rendered signal, and increase a sound field width of the binaural rendered signal.

To achieve the objectives, this application provides the following technical solutions.

According to a first aspect, this application provides an audio rendering method. The method includes: obtaining a to-be-rendered audio signal; determining K first combined HRTFs based on K first head-related transfer functions (HRTFS) and K second HRTFs, where the K first combined HRTFs are left-ear HRTFs for processing the to-be-rendered audio signal, the K first HRTFs are left-ear HRTFs for processing a low frequency band signal in the to-be-rendered audio signal, and the K second HRTFs are left-ear HRTFs for processing a high frequency band signal in the to-be-rendered audio signal, where K is a positive integer; determining K second combined HRTFs based on K third HRTFs and K fourth HRTFs, where the K second combined HRTFs are right-ear HRTFs for processing the to-be-rendered audio signal, the K third HRTFs are right-ear HRTFs for processing the low frequency band signal in the to-be-rendered audio signal, and the K fourth HRTFs are right-ear HRTFs for processing the high frequency band signal in the to-be-rendered audio signal; and determining a first target rendered signal based on the K first combined HRTFs and the to-be-rendered audio signal, where the first target rendered signal is a rendered signal output to the left ear of a listener; and determining a second target rendered signal based on the K second combined HRTFs and the to-be-rendered audio signal, where the second target rendered signal is a rendered signal output to the right ear of the listener.

According to this embodiment, the K first combined HRTFs obtained based on the left-ear HRTFs (that is, the K first HRTFs) for processing the low frequency band signal in the to-be-rendered audio signal and the left-ear HRTFs (that is, the K second HRTFs) for processing the high frequency band signal in the to-be-rendered audio signal are used to process the to-be-rendered audio signal. This can improve accuracy of an ITD of a binaural rendered signal. The K second combined HRTFs obtained based on the right-ear HRTFs (that is, the K third HRTFs) for processing the low frequency band signal in the to-be-rendered audio signal and the right-ear HRTFs (that is, the K fourth HRTFs) for processing the high frequency band signal in the to-be-rendered audio signal are used to process the to-be-rendered audio signal. This can improve accuracy of an ILD of the binaural rendered signal. In this way, the high-accuracy ITD and ILD improve accuracy of sound image localization performed based on the binaural rendered signal, reduce in-head effect of the binaural rendered signal, and increase a sound field width of the binaural rendered signal.

In an embodiment, the first HRTF and the second HRTF are determined based on a same left-ear HRTF; and the third HRTF and the fourth HRTF are determined based on a same right-ear HRTF.

In another embodiment, before the “determining K first combined HRTFs based on K first HRTFs and K second HRTFs”, the method further includes: obtaining K left-ear initial HRTFs, where the K left-ear initial HRTFs are left-ear HRTFs measured based on signals of K virtual speakers by using the position of the center of the head of the listener as a sweet spot, and the K left-ear initial HRTFs one-to-one correspond to the signals of the K virtual speakers; and determining the K first HRTFs and the K second HRTFs based on the K left-ear initial HRTFs. Before the “determining K second combined HRTFs based on K third HRTFs and K fourth HRTFs”, the method further includes: obtaining K right-ear initial HRTFs, where the K right-ear initial HRTFs are right-ear HRTFs measured based on the signals of the K virtual speakers by using the position of the center of the head of the listener as the sweet spot, and the K right-ear initial HRTFs one-to-one correspond to the signals of the K virtual speakers; and determining the K third HRTFs and the K fourth HRTFs based on the K right-ear initial HRTFs. The K virtual speakers are K virtual speakers that are disposed by using the position of the center of the head of the listener as the sweet spot.

In another embodiment, the “determining the K first HRTFs and the K second HRTFs based on the K left-ear initial HRTFs” includes: performing low-pass filtering processing on the K left-ear initial HRTFs to obtain the K first HRTFs, and performing high-pass filtering processing on the K left-ear initial HRTFs to obtain the K second HRTFs. The “determining the K third HRTFs and the K fourth HRTFs based on the K right-ear initial HRTFs” includes: performing low-pass filtering processing on the K right-ear initial HRTFs to obtain the K third HRTFs, and performing high-pass filtering processing on the K right-ear initial HRTFs to obtain the K fourth HRTFs.

According to the foregoing three possible designs, an audio rendering apparatus may perform high-pass and low-pass filtering on general-purpose HRTFs (that is, the K left-ear initial HRTFs and the K right-ear initial HRTFs), to obtain the K first HRTFs and the K second HRTFs and determine the K third HRTFs and the K fourth HRTFs. In this case, the audio rendering apparatus may obtain, based on the K first HRTFs and the K second HRTFs, the K first combined HRTFs for processing the to-be-rendered audio signal; and obtain, based on the K second HRTFs and the K fourth HRTFs, the K second combined HRTFs for processing the to-be-rendered audio signal. In this way, when the to-be-rendered audio signal is processed by using the K first combined HRTFs and the K second combined HRTFs, accuracy of an ITD and ILD of a binaural rendered signal can be improved. This improves accuracy of sound image localization performed based on the binaural rendered signal, reduces in-head effect of the binaural rendered signal, and increases a sound field width of the binaural rendered signal.

In another embodiment, the “determining the K first HRTFs and the K second HRTFs based on the K left-ear initial HRTFs” includes: performing low-pass filtering processing and delay processing on the K left-ear initial HRTFs to obtain the K first HRTFs, and performing high-pass filtering processing on the K left-ear initial HRTFs to obtain the K second HRTFs; or performing low-pass filtering processing on the K left-ear initial HRTFs to obtain the K first HRTFs, and performing high-pass filtering processing and delay processing on the K left-ear initial HRTFs to obtain the K second HRTFs. The “determining the K third HRTFs and the K fourth HRTFs based on the K right-ear initial HRTFs” includes: performing low-pass filtering processing and delay processing on the K right-ear initial HRTFs to obtain the K third HRTFs, and performing high-pass filtering processing on the K right-ear initial HRTFs to obtain the K fourth HRTFs; or performing low-pass filtering processing on the K right-ear initial HRTFs to obtain the K third HRTFs, and performing high-pass filtering processing and delay processing on the K right-ear initial HRTFs to obtain the K fourth HRTFs.

According to this possible design, after performing high-pass and low-pass filtering on general-purpose HRTFs (that is, the K left-ear initial HRTFs and the K right-ear initial HRTFs), the audio rendering apparatus further performs delay processing on high-pass filtered K left-ear initial HRTFs or low-pass filtered K left-ear initial HRTFs, and perform delay processing on high-pass filtered K right-ear initial HRTFs or low-pass filtered K right-ear initial HRTFs, to obtain the K first HRTFs and the K second HRTFs and determine K third HRTFs and K fourth HRTFs. In this case, detrimental effect of the K first combined HRTFs obtained based on the K first HRTFs and the K second HRTFs can be eliminated, and detrimental effect of the K second combined HRTFs obtained based on the K third HRTFs and the K fourth HRTFs can be eliminated, thereby improving quality of a finally rendered signal.

In another embodiment, the to-be-rendered audio signal includes J channel signals, where J is a positive integer. The “determining a first target rendered signal based on the K first combined HRTFs and the to-be-rendered audio signal” includes: transforming the K first combined HRTFs into a to-be-rendered audio signal domain to obtain J first target HRTFs, where the J first target HRTFs are left-ear HRTFs in the to-be-rendered audio signal domain, and the J first target HRTFs one-to-one correspond to the J channel signals; and determining the first target rendered signal based on the J first target HRTFs and the J channel signals. The “determining a second target rendered signal based on the K second combined HRTFs and the to-be-rendered audio signal” includes: transforming the K second combined HRTFs into the to-be-rendered audio signal domain to obtain J second target HRTFs, where the J second target HRTFs are right-ear HRTFs in the to-be-rendered audio signal domain, and the J second target HRTFs one-to-one correspond to the J channel signals; and determining the second target rendered signal based on the J second target HRTFs and the J channel signals.

In another embodiment, the “determining the first target rendered signal based on the J first target HRTFs and the J channel signals” includes: convolving each of the J first target HRTFs with a corresponding channel signal in the J channel signals to obtain the first target rendered signal. The “determining the second target rendered signal based on the J second target HRTFs and the J channel signals” includes: convolving each of the J second target HRTFs with a corresponding channel signal in the J channel signals to obtain the second target rendered signal.

According to the embodiments, the audio rendering apparatus transforms the K first combined HRTFs and the K second combined HRTFs into the to-be-rendered audio signal domain, and processes the to-be-rendered audio signal by using the to-be-rendered audio signal domain, to improve accuracy of an ITD and ILD of a binaural rendered signal. This improves accuracy of sound image localization performed based on the binaural rendered signal, reduces in-head effect of the binaural rendered signal, and increases a sound field width of the binaural rendered signal.

In another embodiment, the “obtaining a to-be-rendered audio signal” includes: receiving the to-be-rendered audio signal obtained by an audio decoder through decoding, receiving the to-be-rendered audio signal collected by an audio collector, or obtaining the to-be-rendered audio signal obtained by performing synthesis processing on a plurality of audio signals.

According to this possible design, the audio rendering method provided in this application may be applied to a plurality of different application scenarios.

According to a second aspect, this application provides an audio rendering method. The method includes: obtaining a to-be-rendered audio signal; dividing the to-be-rendered audio signal into a high frequency band signal and a low frequency band signal; determining, by using a first position as a sweet spot, a first rendered signal corresponding to the high frequency band signal; determining, by using a second position as a sweet spot, a second rendered signal corresponding to the high frequency band signal, where the second position is the position of the right ear of a listener when the first position is the position of the left ear of the listener, or the second position is the position of the left ear of the listener when the first position is the position of the right ear of the listener; determining, by using the position of the center of the head of the listener as a sweet spot, a third rendered signal and a fourth rendered signal that correspond to the low frequency band signal, wherein the third rendered signal is used to determine a rendered signal output to the first position, and the fourth rendered signal is used to determine a rendered signal output to the second position; and combining the first rendered signal and the third rendered signal to obtain a first target rendered signal, and combining the second rendered signal and the fourth rendered signal to obtain a second target rendered signal. The first target rendered signal is a rendered signal output to the first position, and the second target rendered signal is a rendered signal output to the second position.

In this embodiment, an audio rendering apparatus divides the to-be-rendered audio signal into the high frequency band signal and the low frequency band signal, and renders the high frequency band signal by using the positions of the two ears of the listener as the sweet spots. This improves accuracy of an interaural level difference (ILD) of a rendered signal. The audio rendering apparatus renders the low frequency band signal by using the position of the center of the head of the listener as the sweet spot. This improves accuracy of an interaural time difference (ITD) of the rendered signal. In this way, the binaural rendered signal obtained by using the audio rendering method provided in this embodiment of this application has a high-accuracy ITD and ILD. This improves accuracy of sound image localization performed based on a binaural rendered signal, reduces in-head effect of the binaural rendered signal, and increases a sound field width of the binaural rendered signal.

In an embodiment, the “combining the first rendered signal and the third rendered signal to obtain a first target rendered signal, and combining the second rendered signal and the fourth rendered signal to obtain a second target rendered signal” includes: separately performing fade-in processing on a signal in a transition band of the first rendered signal and a signal in a transition band of the second rendered signal, and separately performing fade-out processing on a signal in a transition band of the third rendered signal and a signal in a transition band of the fourth rendered signal, where the transition band is a frequency band with a frequency range between a critical frequency between the high frequency band signal and the low frequency band signal minus a second bandwidth, and the critical frequency plus a first bandwidth; obtaining a first combined signal based on a fade-in processed first rendered signal and a fade-out processed third rendered signal, and obtaining a second combined signal based on a fade-in processed second rendered signal and a fade-out processed fourth rendered signal; and combining the first combined signal, a signal beyond the transition band of the first rendered signal, and a signal beyond the transition band of the third rendered signal to obtain the first target rendered signal; and combining the second combined signal, a signal beyond the transition band of the second rendered signal, and a signal beyond the transition band of the fourth rendered signal to obtain the second target rendered signal.

In another embodiment, the “separately performing fade-in processing on a signal in a transition band of the first rendered signal and a signal in a transition band of the second rendered signal” includes: separately performing fade-in processing on the signal in the transition band of the first rendered signal and the signal in the transition band of the second rendered signal by using a fade-in factor. The “separately performing fade-out processing on a signal in a transition band of the third rendered signal and a signal in a transition band of the fourth rendered signal” includes: separately performing fade-out processing on the signal in the transition band of the third rendered signal and the signal in the transition band of the fourth rendered signal by using a fade-out factor. The transition band corresponds to T combinations of a fade-in factor and a fade-out factor, where T is a positive integer, and a sum of a fade-in factor and a fade-out factor that correspond to any one of the T combinations is 1.

In the two possible designs, the first rendered signal and the third rendered signal may be gradually combined together to obtain the smooth first target rendered signal, and the second rendered signal and the fourth rendered signal may be gradually combined together to obtain the smooth second target rendered signal. This improves quality of the first target rendered signal and quality of the second target rendered signal.

In another embodiment, before the “combining the first rendered signal and the third rendered signal to obtain a first target rendered signal, and combining the second rendered signal and the fourth rendered signal to obtain a second target rendered signal”, the method further includes: performing group delay filtering processing on the first rendered signal or the third rendered signal, so that a group delay of a first rendered signal obtained through group delay filtering processing or a third rendered signal obtained through group delay filtering processing is a fixed value; and performing group delay filtering processing on the second rendered signal or the fourth rendered signal, so that a group delay of a second rendered signal obtained through group delay filtering processing or a fourth rendered signal obtained through group delay filtering processing is a fixed value. The “combining the first rendered signal and the third rendered signal to obtain a first target rendered signal” includes: combining a rendered signal obtained through group delay filtering processing and a rendered signal that does not undergo group delay filtering processing, to obtain the first target rendered signal, where the rendered signal obtained through group delay filtering processing and the rendered signal that does not undergo group delay filtering processing are in the first rendered signal and the third rendered signal. The “combining the second rendered signal and the fourth rendered signal to obtain a second target rendered signal” includes: combining a rendered signal obtained through group delay filtering processing and a rendered signal that does not undergo group delay filtering processing, to obtain the second target rendered signal, where the rendered signal obtained through group delay filtering processing and the rendered signal that does not undergo group delay filtering processing are in the second rendered signal and the fourth rendered signal.

According to this possible design, group delay effect of the first combined signal obtained by combining the first rendered signal and the third rendered signal can be eliminated, and group delay effect of the second combined signal obtained by combining the second rendered signal and the fourth rendered signal can be eliminated.

In another possible design manner, the “determining, by using a first position as a sweet spot, a first rendered signal corresponding to the high frequency band signal; and determining, by using a second position as a sweet spot, a second rendered signal corresponding to the high frequency band signal” includes: obtaining, by using the first position as the sweet spot, M first signals corresponding to the high frequency band signal, where the M first signals are signals of M virtual speakers, and the M first signals one-to-one correspond to the M virtual speakers, where M is a positive integer; obtaining, by using the second position as the sweet spot, N second signals corresponding to the high frequency band signal, where the N second signals are signals of N virtual speakers, and the N second signals one-to-one correspond to the N virtual speakers, where N is a positive integer, and N=M; obtaining M first head-related transfer functions (HRTFS) and N second HRTFs, where the M first HRTFs one-to-one correspond to the M first signals, and the N second HRTFs one-to-one correspond to the N second signals; and determining the first rendered signal based on the M first signals and the M first HRTFs, and determining the second rendered signal based on the N second signals and the N second HRTFs.

According to this possible design, the high frequency band signal is rendered by using the positions of the two ears (that is, the first position and the second position) of the listener as the sweet spots, so that accuracy of an ILD of a rendered signal can be improved. This can improve accuracy of sound image localization performed based on a binaural rendered signal, reduce in-head effect of the binaural rendered signal, and increase a sound field width of the binaural rendered signal.

In another possible design manner, the “obtaining, by using the first position as the sweet spot, M first signals corresponding to the high frequency band signal” includes: processing the high frequency band signal to obtain the M first signals of the M virtual speakers, where the M virtual speakers are M virtual speakers disposed by using the first position as the sweet spot. The “obtaining, by using the second position as the sweet spot, N second signals corresponding to the high frequency band signal” includes: processing the high frequency band signal to obtain the N second signals of the N virtual speakers, where the N virtual speakers are N virtual speakers disposed by using the second position as the sweet spot.

In another possible design manner, the method further includes: processing the high frequency band signal to obtain X initial signals corresponding to X virtual speakers. The X initial signals one-to-one correspond to the X virtual speakers, and the X virtual speakers are X virtual speakers disposed by using the position of the center of the head as the sweet spot, where X is a positive integer, and X=M=N. The “obtaining, by using the first position as the sweet spot, M first signals corresponding to the high frequency band signal” includes: separately rotating the X initial signals by a first angle to obtain the M first signals. The first angle is an included angle between a first connection line and a second connection line, the first connection line is a connection line between a position of a first virtual speaker and the position of the center of the head, the second connection line is a connection line between the position of the first virtual speaker and the first position, and the first virtual speaker is any one of the X virtual speakers. The “obtaining, by using the second position as the sweet spot, N second signals corresponding to the high frequency band signal” includes: separately rotating the X initial signals by a second angle to obtain the N second signals. The second angle is an included angle between the first connection line and a third connection line, and the third connection line is a connection line between the position of the first virtual speaker and the second position.

According to the two possible designs, the audio rendering apparatus may directly determine the M first signals and the N second signals based on the high frequency band signal. Alternatively, the audio rendering apparatus may first determine, based on the high frequency band signal, the signals of the X virtual speakers disposed by using the position of the center of the head as the sweet spot, and then further determine the M first signals and the N second signals based on the signals of the X virtual speakers. This improves flexibility of implementing the solutions of this application.

In another possible design manner, the M first HRTFs are HRTFs of the first position that are measured based on the M first signals by using the first position as the sweet spot, and the N second HRTFs are HRTFs of the second position that are measured based on the N second signals by using the second position as the sweet spot.

In another possible design manner, the “obtaining M HRTFs and N second HRTFs” includes: obtaining Y initial HRTFs, where the Y initial HRTFs are HRTFs of the position of the center of the head that are measured based on signals of Y virtual speakers by using the position of the center of the head as a sweet spot, the Y virtual speakers are Y virtual speakers that are disposed by using the position of the center of the head as the sweet spot, and the Y initial HRTFs one-to-one correspond to the signals of the Y virtual speakers, where Y is a positive integer, and Y=M=N; separately rotating the Y initial HRTFs by a third angle, to obtain the M first HRTFs, where the third angle is an included angle between the third connection line and a fourth connection line, the third connection line is a connection line between a position of a second virtual speaker and the position of the center of the head, the fourth connection line is a connection line between the position of the second virtual speaker and the first position, and the second virtual speaker is any one of the Y virtual speakers; and separately rotating the Y initial HRTFs by a fourth angle to obtain the N second HRTFs, where the fourth angle is an included angle between the third connection line and a fifth connection line, and the fifth connection line is a connection line between the position of the second virtual speaker and the second position.

According to the two possible designs, the audio rendering apparatus may directly determine the M first HRTFs based on the M first signals, and determine the N second HRTFs based on the N second signals. Alternatively, the audio rendering apparatus may first determine the Y initial HRTFs of the position of the center of the head that are measured based on the signals of the Y virtual speakers by using the position of the center of the head as the sweet spot, and then determine the M first HRTFs and the N second HRTFs based on the Y initial HRTFs. This improves flexibility of implementing the solutions of this application.

In another possible design manner, the “determining, by using the position of the center of the head of the listener as a sweet spot, a third rendered signal and a fourth rendered signal that correspond to the low frequency band signal” includes: processing the low frequency band signal to obtain R third signals, where the R third signals are signals of R virtual speakers, the R third signals one-to-one correspond to the R virtual speakers, and the R virtual speakers are R virtual speakers disposed by using the position of the center of the head as the sweet spot, where R is a positive integer; obtaining R third HRTFs, where the R third HRTFs are HRTFs of the first position that are measured based on the R third signals by using the position of the center of the head as the sweet spot, and the R third HRTFs one-to-one correspond to the R third signals; obtaining R fourth HRTFs, where the R fourth HRTFs are HRTFs of the second position that are measured based on the R third signals by using the position of the center of the head as the sweet spot, and the R fourth HRTFs one-to-one correspond to the R third signals; and determining the third rendered signal based on the R third signals and the R third HRTFs, and determining the fourth rendered signal based on the R fourth signals and the R fourth HRTFs.

In this possible design, the low frequency band signal is rendered by using the position of the center of the head of the listener as the sweet spot, so that accuracy of an ITD of a rendered signal can be improved. This can improve accuracy of sound image localization performed based on a binaural rendered signal, reduce in-head effect of the binaural rendered signal, and increase a sound field width of the binaural rendered signal.

In another possible design manner, the “obtaining a to-be-rendered audio signal” includes: receiving the to-be-rendered audio signal obtained by an audio decoder through decoding, receiving the to-be-rendered audio signal collected by an audio collector, or obtaining the to-be-rendered audio signal obtained by performing synthesis processing on a plurality of audio signals.

According to this possible design, the audio rendering method provided in this application may be applied to a plurality of different application scenarios.

According to a third aspect, this application provides an audio rendering apparatus.

In a possible design manner, the audio rendering apparatus is configured to perform either one of the methods provided in the first aspect or the second aspect. In this application, the audio rendering apparatus may be divided into functional modules according to either one of the methods provided in the first aspect or the second aspect. For example, each functional module may be obtained through division based on a corresponding function, or two or more functions may be integrated into one processing module. For example, in this application, the audio rendering apparatus may be divided into an obtaining unit, a division unit, a determining unit, a combination unit, and the like based on functions. Alternatively, in this application, the audio rendering apparatus may be divided into an obtaining unit, a determining unit, and the like based on functions. For descriptions of possible technical solutions performed by the foregoing functional modules obtained through division and beneficial effects, refer to the technical solutions provided in the first aspect or the corresponding possible designs of the first aspect, or refer to the technical solutions provided in the second aspect or the corresponding possible designs of the second aspect. Details are not described herein again.

In another possible design, the audio rendering apparatus includes a memory and one or more processors, and the memory is coupled to the processor. The memory is configured to store computer instructions, and the processor is configured to invoke the computer instructions, to perform the method provided in any one of the first aspect and the possible design manners of the first aspect, or perform the method provided in any one of the second aspect and the possible design manners of the second aspect.

According to a fourth aspect, this application provides a computer-readable storage medium, for example, a non-transient computer-readable storage medium. The computer-readable storage medium stores a computer program (or instructions). When the computer program (or the instructions) is/are run on an audio rendering apparatus, the audio rendering apparatus is enabled to perform the method provided in any one of the embodiments of the first aspect or the second aspect.

According to a fifth aspect, this application provides a computer program product. When the computer program product runs on an audio rendering apparatus, the method provided in any one of the embodiment of the first aspect or the second aspect is performed.

According to a sixth aspect, this application provides a chip system, including a processor. The processor is configured to: invoke, from a memory, a computer program stored in the memory, and run the computer program, to perform any one of the methods provided in the implementations of the first aspect or the second aspect.

According to a seventh aspect, this application provides a computer-readable storage medium, configured to store a bitstream generated according to any one of the embodiment of the first aspect or the second aspect.

It may be understood that any one of the apparatus, the computer storage medium, the computer program product, the chip system, or the like provided above may be applied to a corresponding method provided above. Therefore, for beneficial effects that can be achieved by the apparatus, the computer storage medium, the computer program product, the chip system, or the like, refer to the beneficial effects of the corresponding method. Details are not described herein again.

In this application, a name of the foregoing audio rendering apparatus does not constitute any limitation on the devices or functional modules. During actual implementation, these devices or functional modules may have other names. Each device or functional module falls within the scope defined by the claims and their equivalent technologies in this application, provided that a function of the device or functional module is similar to that described in this application.

These aspects or other aspects in this application are more concise and comprehensible in the following descriptions.

### BRIEF DESCRIPTION OF DRAWINGS

FIG. 1 is a schematic diagram of a structure of an audio and video system according to an embodiment of this application;

FIG. 2 is a schematic diagram of a structure of a terminal device according to an embodiment of this application;

FIG. 3 is a schematic flowchart 1 of an audio rendering method according to an embodiment of this application;

FIG. 4 is a scene diagram 1 of positions of virtual speakers according to an embodiment of this application;

FIG. 5 is a scene diagram 2 of positions of virtual speakers according to an embodiment of this application;

FIG. 6 is a schematic diagram of an extreme case of detrimental effect of an audio signal according to an embodiment of this application;

FIG. 7 is a schematic diagram of group delay filtering according to an embodiment of this application;

FIG. 8 is a schematic diagram of signal fade-in/fade-out according to an embodiment of this application;

FIG. 9 is a schematic flowchart 2 of an audio rendering method according to an embodiment of this application;

FIG. 10 is a schematic flowchart 3 of an audio rendering method according to an embodiment of this application;

FIG. 11 is a schematic diagram of a first angle and a second angle according to an embodiment of this application;

FIG. 12 is a schematic diagram of a third angle and a fourth angle according to an embodiment of this application;

FIG. 13 is a schematic flowchart 4 of an audio rendering method according to an embodiment of this application;

FIG. 14 is a schematic diagram of low-pass filtering according to an embodiment of this application;

FIG. 15 is a schematic diagram of high-pass filtering according to an embodiment of this application;

FIG. 16 is a schematic diagram 1 of a structure of an audio rendering apparatus according to an embodiment of this application;

FIG. 17 is a schematic diagram 2 of a structure of an audio rendering apparatus according to an embodiment of this application;

FIG. 18 is a schematic diagram of a structure of a chip system according to an embodiment of this application; and

FIG. 19 is a schematic diagram of a structure of a computer program product according to an embodiment of this application.

### DESCRIPTION OF EMBODIMENTS

The following describes some terms or technologies in embodiments of this application:

(1) Header-Related Transfer Function (HRTF)

A sound wave emitted by a sound source reaches two ears after being scattered by the head, auricles, and trunk. A physical process can be considered as a linear time-invariant sound filtering system, and characteristics thereof can be described by the HRTF. In other words, the HRTF describes a transmission process of the sound wave from a sound source to the two ears.

A more vivid explanation of the HRTF is as follows: If an audio signal sent by the sound source is X, and an audio signal obtained after the audio signal X is delivered to a preset position is Y, X⊗Z=Y (Y is obtained by convolving X with Z), where Z is the HRTF.

(2) Sweet Spot

When a segment of audio is played simultaneously by using a plurality of speakers (or speaker devices) located in different positions, an optimal position in which a listener listens to the audio is a sweet spot of the plurality of speakers.

For example, a plurality of sounding devices (that is, speaker devices) are usually disposed around a movie theater. Usually, an audience can enjoy good cinematic sound effect in a position near the middle of the movie theater. Therefore, the position is a sweet spot of the plurality of sounding devices.

(3) In-Head Effect

In-head effect is common in headphones, especially in-ear earphones. When audio (for example, music) is listened to by using headphones, it feels like that the music exists in the brain of the listener instead of in space in which the listener is located. A good sound field can create a good sense of presence, so that the listener feels like being in the center of a concert hall and is surrounded by sounds of surrounding (external) instruments.

(4) Sound Image Localization

Sound image localization means that sound image of audio (for example, a musical instrument or a human voice) can be accurately localized, and even features of a sound field can be clearly determined. Herein, the sound field refers to an area in which a sound wave exists and that is in a medium.

A same angle or different angles may be formed between a sound source and the ears of the listener. Due to an angle difference, a tiny time difference is generated when the audio played by the sound source is delivered from a position of the sound source to the left and right ears of the listener. Physiological characteristics of human ears are very sensitive to the tiny time difference, and therefore a person can produce an accurate sense of direction. In addition, due to the angle difference, for the audio played by the sound source, a tiny difference is generated between distances from the position of the sound source to the left and right ears of the listener. The human ears may generate a sense of distance by using a tiny difference between sound strength. In this way, the sound image is accurately localized.

(5) Other Terms

In addition, in embodiments of this application, the word “example”, “for example”, or the like is used to represent giving an example, an illustration, or a description. Any embodiment or design scheme described as an “example” or “for example” in embodiments of this application should not be explained as being more preferred or having more advantages than another embodiment or design scheme. Exactly, use of the word “example”, “for example”, or the like is intended to present a related concept in a specific manner.

The terms “first” and “second” in embodiments of this application are merely intended for a purpose of description, and shall not be understood as an indication or implication of relative importance or implicit indication of a quantity of indicated technical features. Therefore, a feature limited by “first” or “second” may explicitly or implicitly include one or more features.

In the descriptions of this application, unless otherwise stated, “a plurality of” means two or more than two. In this application, “at least one” means one or more and “a plurality of” means two or more.

It should be understood that the terms used in the descriptions of various examples in this specification are merely intended to describe specific examples but are not intended to constitute a limitation. The terms “one” (“a” and “an”) and “the” of singular forms used in the descriptions of various examples and the appended claims are also intended to include plural forms, unless otherwise specified in the context clearly.

It should be further understood that the term “and/or” used in this specification indicates and includes any or all combinations of one or more items in associated listed items. The term “and/or” describes an association relationship between associated objects and represents that three relationships may exist. For example, A and/or B may represent the following three cases: Only A exists, both A and B exist, and only B exists. In addition, the character “I” in this application generally indicates an “or” relationship between the associated objects.

It should be further understood that sequence numbers of processes do not mean execution sequences in embodiments of this application. The execution sequences of the processes should be determined based on functions and internal logic of the processes, and should not be construed as any limitation on the implementation processes of embodiments of this application.

It should be understood that determining B based on A does not mean that B is determined based on only A, but B may alternatively be determined based on A and/or other information.

It should be further understood that when being used in this specification, the term “include” (also referred to as “includes”, “including”, “comprises”, and/or “comprising”) specifies presence of stated features, integers, steps, operations, elements, and/or components, but does not preclude presence or addition of one or more other features, integers, steps, operations, elements, components, and/or groups thereof.

It should be further understood that the term “if” may be interpreted as “when” (“when” or “upon”), “in response to determining”, or “in response to detecting”. Similarly, according to the context, the phrase “if it is determined that” or “if (a stated condition or event) is detected” may be interpreted as a meaning of “when it is determined that”, “in response to determining”, “when (a stated condition or event) is detected”, or “in response to detecting (a stated condition or event)”.

It should be understood that “one embodiment”, “an embodiment”, and “a possible implementation” mentioned in the entire specification mean that particular features, structures, or characteristics related to the embodiment or the implementation are included in at least one embodiment of this application. Therefore, “in one embodiment”, “in an embodiment”, or “in a possible implementation” appearing throughout this specification does not necessarily mean a same embodiment. In addition, these particular features, structures, or characteristics may be combined in one or more embodiments by using any appropriate manner.

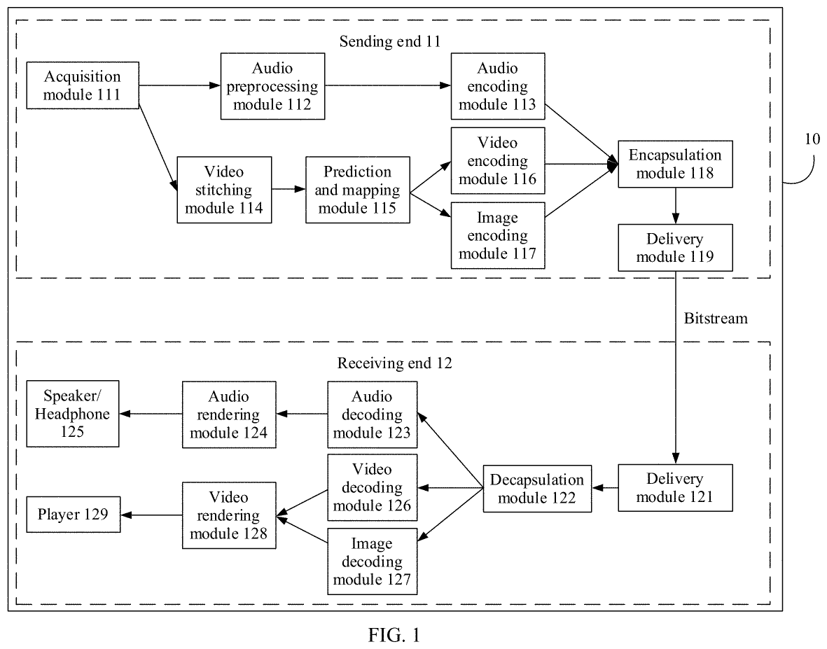

FIG. 1 is a schematic diagram of a structure of an audio and video system 10 according to an embodiment of this application. The audio and video system 10 may be a VR system, an AR system, an MR system, or another streaming transmission system. Certainly, an actual form of the audio and video system 10 is not limited in this embodiment of this application. As shown in FIG. 1, the audio and video system 10 includes a sending end 11 and a receiving end 12.

The sending end 11 is configured to: collect an audio signal and a video signal, and separately encode the audio signal and the video signal to obtain a bitstream. As shown in FIG. 1, the sending end 11 may include an acquisition module 111, an audio preprocessing module 112, an audio encoding module 113, a visual stitching (visual stitching) module 114, a projection and mapping module 115, a video encoding module 116, an image encoding 117 module, an encapsulation module (file/segment encapsulation) 118, and a delivery module (delivery) 119.

The acquisition module 111 may be configured to: acquire an audio signal from a sound source, and deliver the audio signal to the audio preprocessing module 112 for preprocessing. The acquisition module 111 may be further configured to acquire a video signal. After the visual stitching module 114, the projection and mapping module 115, the video encoding module 116, and the image encoding module 117 process the video signal, an encoded video signal is delivered to the encapsulation module 118.

The audio preprocessing module 112 is configured to preprocess the audio signal acquired by the acquisition module 111, for example, filter out a low-frequency part in the audio signal by using 20 Hz or 50 Hz as a critical frequency. Then, the audio preprocessing module 112 delivers a preprocessed audio signal to the audio encoding module 113.

The audio encoding module 113 is configured to: encode the preprocessed audio signal, and deliver an encoded audio signal to the encapsulation module 118.

The encapsulation module 118 is configured to encapsulate the encoded audio signal and the encoded video signal to obtain a bitstream, where the bitstream is delivered to a delivery module 121 of the receiving end 12 through the delivery module 119. For example, the delivery module 119 and the delivery module 121 may be wired communication modules or wireless communication modules. This is not limited in this embodiment of this application.

It should be noted that the delivery module 119 may be implemented in a form of a server when the audio and video system 10 is a streaming transmission system. To be specific, the sending end 11 uploads the bitstream to the server, and the receiving end 12 downloads the bitstream from the server according to a requirement, to implement a function of the delivery module 119. Details of this process are not described again.

The receiving end 12 is configured to: acquire the bitstream delivered by the delivery module 119, and decode the bitstream to obtain the audio signal and the video signal. Then, the receiving end 12 separately renders the audio signal and the video signal, and play rendered audio or a rendered video. As shown in FIG. 1, the receiving end 12 may include the delivery module 121, a decapsulation (file/segment decapsulation) module 122, an audio decoding module 123, an audio rendering module 124, a speaker/headphone (loudspeakers/headphones) 125, a video decoding module 126, an image decoding module 127, a video rendering module 128, and a player (display) 129.

The delivery module 121 is configured to: obtain the bitstream delivered by the delivery module 119, and deliver the bitstream to the decapsulation module 122.

The decapsulation module 122 is configured to: decapsulate the bitstream to obtain the encoded audio signal and the encoded video signal, deliver the encoded audio signal to the audio decoding module 123, and deliver the encoded video signal to the video decoding module 126 and the image decoding module 127.

The audio decoding module 123 is configured to: decode the encoded audio signal, and deliver a decoded audio signal to the audio rendering module 124.

The audio rendering module 124 is configured to: perform rendering processing on the decoded audio signal, and deliver a rendered signal to the speaker/headphone 209 for playing.

The video decoding module 126, the image decoding module 127, and the video rendering module 128 are configured to process the encoded video signal, and a processed video signal is delivered to the player 129 for playing.

It should be noted that the structure shown in FIG. 1 does not constitute a limitation on the audio and video system 10. The audio and video system 10 may include more or fewer components than those shown in the figure, combine some components, or have different component arrangements.

It may be understood that the sending end 11 and the receiving end 12 may be disposed in different terminal devices, or certainly, may be disposed in a same terminal device. This is not limited in this embodiment of this application. The terminal device may be an electronic device having an audio and video signal processing capability, for example, may be a mobile phone, a wearable device, a VR device, or an AR device. This is not limited.

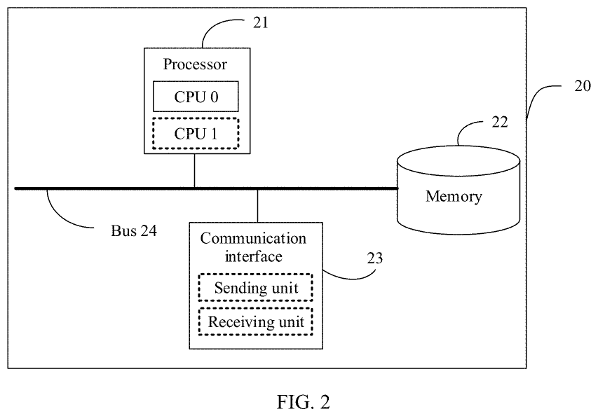

FIG. 2 is a schematic diagram of a structure of a terminal device 20 according to an embodiment of this application. The terminal device 20 may be the sending end 11 in FIG. 1, the receiving end 12 in FIG. 1, or a terminal device including the sending end 11 and the receiving end 12 in FIG. 1. This is not limited in this embodiment of this application. As shown in FIG. 2, the terminal device 20 includes a processor 21, a memory 22, a communication interface 23, and a bus 24. The processor 21, the memory 22, and the communication interface 23 may be connected through the bus 24.

The processor 21 is a control center of the terminal device 20, and may be a general-purpose central processing unit (CPU), another general-purpose processor, or the like. The general-purpose processor may be a microprocessor, any conventional processor, or the like.

For example, the processor 21 may include one or more CPUs, for example, a CPU 0 and a CPU 1 that are shown in FIG. 2.

The memory 22 may be a read-only memory (ROM) or another type of static storage device capable of storing static information and instructions, a random access memory (RAM) or another type of dynamic storage device capable of storing information and instructions, an electrically erasable programmable read-only memory (EEPROM), a magnetic disk storage medium or another magnetic storage device, or any other medium capable of carrying or storing expected program code in a form of an instruction or data structure and capable of being accessed by a computer, but is not limited thereto.

In an embodiment, the memory 22 may be independent of the processor 21. The memory 22 may be connected to the processor 21 through the bus 24, and is configured to store data, instructions, or program code. When invoking and executing the instructions or the program code stored in the memory 22, the processor 21 can implement an audio rendering method provided in embodiments of this application.

In another embodiment, the memory 22 may alternatively be integrated with the processor 21.

The communication interface 23 is configured to connect the terminal device 20 to another device (such as a server) through a communication network. The communication network may be the Ethernet, a radio access network (RAN), a wireless local area network (WLAN), or the like. The communication interface 23 may include a receiving unit configured to receive data and a sending unit configured to send data.

It should be understood that functions of the receiving unit and the sending unit may be similar to or the same as those of the delivery module 119 and the delivery module 120 in FIG. 1.

The bus 14 may be an industry standard architecture (ISA) bus, a peripheral component interconnect (PCI) bus, an extended industry standard architecture (EISA) bus, or the like. The bus may be classified into an address bus, a data bus, a control bus, and the like. For ease of denotation, the bus is denoted by using only one bold line in FIG. 2. However, this does not indicate that there is only one bus or only one type of bus.

It should be noted that the structure shown in FIG. 2 does not constitute a limitation on the terminal device 20. In addition to the components shown in FIG. 2, the terminal device 20 may include more or fewer components than those shown in the figure, combine some components, or have different component arrangements.

Embodiments of this application provide an audio rendering method and apparatus. The method may be applied to the receiving end 12 of the audio and video system 10 shown in FIG. 1. The method may be applied to the foregoing audio rendering module 124. Alternatively, the method may be applied to the terminal device 20 shown in FIG. 2. When the method is applied to the terminal device 20 shown in FIG. 2, the processor 21 may execute the program instructions in the memory 22 to implement the audio rendering method provided in embodiments of this application. Performing the audio rendering method provided in embodiments of this application can improve accuracy of sound image localization performed based on a binaural rendered signal, reduce in-head effect of the binaural rendered signal, and increase a sound field width of the binaural rendered signal.

The following describes, with reference to the accompanying drawings, the audio rendering methods provided in embodiments of this application.

### Embodiment 1

In this embodiment, an audio rendering apparatus transforms a to-be-rendered audio signal into a virtual speaker signal domain, and renders the to-be-rendered audio signal in the virtual speaker signal domain.

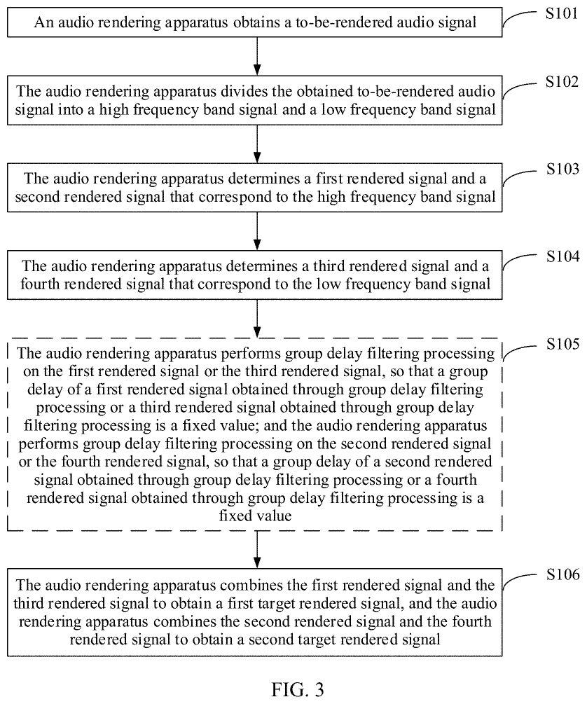

Refer to FIG. 3. FIG. 3 is a schematic flowchart of an audio rendering method according to this embodiment of this application. The method may include the following steps.

S101: The audio rendering apparatus obtains the to-be-rendered audio signal.

The to-be-rendered audio signal may include at least two independent channel signals. Herein, one independent channel signal may be obtained by collecting audio of a sound source by one audio collector. The audio collector may transform the audio of the sound source into an electrical signal, to obtain the one independent channel signal.

Optionally, the to-be-rendered audio signal may be a first-order ambisonics (FOA) signal or a high-order ambisonics (HOA) signal. The FOA signal includes four independent channel signals, and the HOA signal includes (S+1)² independent channel signals. Herein, S is an integer greater than 1. For example, when S is 2, the HOA signal includes nine (that is, (2+1)²) independent channel signals.

Optionally, the audio rendering apparatus may receive the to-be-rendered audio signal obtained by an audio decoder through decoding. For example, the audio rendering apparatus may receive an audio signal decoded by the audio decoding module 123 in FIG. 1, and use the decoded audio signal as the to-be-rendered audio signal.

Optionally, the audio rendering apparatus may receive the to-be-rendered audio signal collected by the audio collector. The audio rendering apparatus may receive at least two channel signals collected by the audio collector, and use the at least two channel signals as the to-be-rendered audio signal for rendering.

Optionally, the audio rendering apparatus may obtain the to-be-rendered audio signal obtained by performing synthesis processing on a plurality of audio signals. Herein, the plurality of audio signals may be mono signals, or may be multi-channel signals. This is not limited.

S102: The audio rendering apparatus divides the obtained to-be-rendered audio signal into a high frequency band signal and a low frequency band signal.

Generally, a frequency range that can be perceived by human ears is approximately 0-20000 Hz. Therefore, a frequency range of the to-be-rendered audio signal may be within 0-20000 Hz.

Optionally, the audio rendering apparatus may divide the to-be-rendered audio signal into the high frequency band signal and the low frequency band signal based on a preset frequency. A value of the preset frequency is not limited in this embodiment of this application. Herein, the preset frequency is a critical frequency between the high frequency band signal and the low frequency band signal.

The audio rendering apparatus may divide, based on the preset frequency f_{c}, the to-be-rendered audio signal into the high frequency band signal with a frequency range (f_{c}, fₛ] and the low frequency band signal with a frequency range [0, f_{c}] if the frequency range of the to-be-rendered audio signal is [0, fₛ]. Alternatively, the audio rendering apparatus may divide, based on the preset frequency f_{c}, the to-be-rendered audio signal into the high frequency band signal with a frequency range [f_{c}, fₛ] and the low frequency band signal with a frequency range [0, f_{c}). 0<fc<fs.

It can be learned that the critical frequency may belong to the frequency range of the high frequency band signal, and/or may belong to the frequency range of the low frequency band signal. This is not limited.

For example, fₛ is 20000 Hz, and f_{c} is 1500 Hz. In this case, the frequency range of the to-be-rendered audio signal is [0, 20000 Hz]. The audio rendering apparatus divides the to-be-rendered audio signal into the high frequency band signal with a frequency range (1500 Hz, 20000 Hz] and the low frequency band signal with a frequency range [0, 1500 Hz] by using 1500 Hz as the critical frequency. Alternatively, the audio rendering apparatus divides the to-be-rendered audio signal into the high frequency band signal with a frequency range [1500 Hz, 20000 Hz] and the low frequency band signal with a frequency range [0, 1500 Hz) by using 1500 Hz as the critical frequency.

S103: The audio rendering apparatus determines a first rendered signal and a second rendered signal that correspond to the high frequency band signal.

The first rendered signal may be a rendered signal obtained by performing, by the audio rendering apparatus, rendering processing on the high frequency band signal by using a first position as a sweet spot. The second rendered signal may be a rendered signal obtained by performing, by the audio rendering apparatus, rendering processing on the high frequency band signal by using a second position as a sweet spot. In this case, the high frequency band signal in the to-be-rendered audio signal is rendered by using the positions of the two ears of a listener as the sweet spots. This can improve accuracy of an interaural level difference (ILD) of the rendered signal. In this way, the high-accuracy ILD improves accuracy of sound image localization performed based on a binaural rendered signal, reduces in-head effect of the binaural rendered signal, and increases a sound field width of the binaural rendered signal.

The second position is the position of the right ear of the listener if the first position is the position of the left ear of the listener. In this case, the first rendered signal is a left-ear rendered signal obtained by performing rendering processing on the high frequency band signal, and the second rendered signal is a right-ear rendered signal obtained by performing rendering processing on the high frequency band signal. The second position may be the position of the left ear of the listener if the first position is the position of the right ear of the listener. In this case, the first rendered signal is a right-ear rendered signal obtained by performing rendering processing on the high frequency band signal, and the second rendered signal is a left-ear rendered signal obtained by performing rendering processing on the high frequency band signal. This is not limited.

It may be understood that M virtual speakers are disposed in a preset position of a sweet spot when the first position is the sweet spot. The M virtual speakers are configured to generate M sound source signals, where M is a positive integer. For example, M may be an integer greater than or equal to 3. For another example, a value of M may be greater than or equal to a quantity of channels of the to-be-rendered audio signal. This is not limited in this embodiment of this application.

It may be understood that N virtual speakers are disposed in a preset position of a sweet spot when the second position is the sweet spot. The N virtual speakers are configured to generate N sound source signals, where N is a positive integer, and N=M.

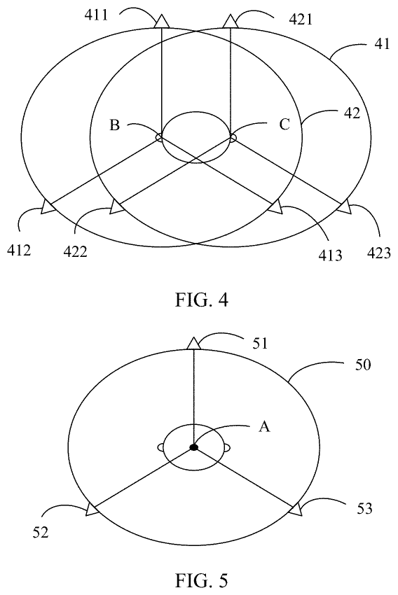

For example, the first position is the position of the left ear of the listener, and the second position is the position of the right ear of the listener. Refer to FIG. 4. FIG. 4 shows distribution of the M virtual speakers disposed when the position of the left ear of the listener is the sweet spot. Herein, an example in which M is 3 is used. As shown in FIG. 4, B is the position of the left ear of the listener. Three virtual speakers (including a virtual speaker 411, a virtual speaker 412, and a virtual speaker 413) may be distributed on an elliptical preset curve 41 if the position B is the sweet spot.

FIG. 4 further shows distribution of the N virtual speakers disposed when the position of the right ear of the listener is the sweet spot. Herein, an example in which N is 3 is used. As shown in FIG. 4, C is the position of the right ear of the listener. Three virtual speakers (including a virtual speaker 421, a virtual speaker 422, and a virtual speaker 423) may be distributed on an elliptical preset curve 42 if the position C is the sweet spot.

The audio rendering apparatus determines, based on the signals of the M disposed virtual speakers, the first rendered signal corresponding to the high frequency band signal, and determines, based on the signals of the disposed N virtual speakers, the second rendered signal corresponding to the high frequency band signal. That is, the audio rendering apparatus transforms the to-be-rendered audio signal into the virtual speaker signal domain, and determines, in the virtual speaker signal domain, a binaural rendered signal corresponding to the high frequency band signal in the to-be-rendered audio signal.

For a specific process in which the audio rendering apparatus determines, based on the signals of the disposed M virtual speakers, the first rendered signal corresponding to the high frequency band signal, and determines, based on the signals of the disposed N virtual speakers, the second rendered signal corresponding to the high frequency band signal, refer to the following descriptions. Details are not described herein again.

S104: The audio rendering apparatus determines a third rendered signal and a fourth rendered signal that correspond to the low frequency band signal.

The third rendered signal and the fourth rendered signal may be rendered signals obtained by performing, by the audio rendering apparatus, rendering processing on the low frequency band signal by using the position of the center of the head of the listener as a sweet spot. In this case, the low frequency band signal in the to-be-rendered audio signal is rendered by using the position of the center of the head of the listener as the sweet spot. This can improve accuracy of an interaural time difference (ITD) of the rendered signal. In this way, the high-accuracy ITD improves accuracy of sound image localization performed based on the binaural rendered signal, reduces in-head effect of the binaural rendered signal, and increases a sound field width of the binaural rendered signal.

It may be understood that R virtual speakers are disposed in a preset position when the position of the center of the head of the listener is the sweet spot. The R virtual speakers are configured to generate R sound source signals, where R is a positive integer. For example, R may be an integer greater than or equal to 3. For another example, a value of R may be greater than or equal to a quantity of channels of the to-be-rendered audio signal. This is not limited in this embodiment of this application.

Refer to FIG. 5. FIG. 5 shows distribution of the R virtual speakers disposed when the position of the center of the head of the listener is the sweet spot. Herein, an example in which R is 3 is used. As shown in FIG. 5, A is the position of the center of the head of the listener. Three virtual speakers (including a virtual speaker 51, a virtual speaker 52, and a virtual speaker 53) may be distributed on an elliptical preset curve 50 if the position A is the sweet spot.

The audio rendering apparatus determines, based on the signals of the disposed R virtual speakers, the third rendered signal and the fourth rendered signal that correspond to the low frequency band signal. That is, the audio rendering apparatus transforms the to-be-rendered audio signal into the virtual speaker signal domain, and determines, in the virtual speaker signal domain, a binaural rendered signal corresponding to the low frequency band signal in the to-be-rendered audio signal.

For a specific process in which the audio rendering apparatus determines, based on the signals of the disposed R virtual speakers, the third rendered signal and the fourth rendered signal that correspond to the low frequency band signal, refer to the following descriptions. Details are not described herein again.

It may be understood that a time sequence of performing S103 and S104 is not limited in this embodiment of this application. For example, in this embodiment of this application, S103 and S104 may be simultaneously performed, or S103 may be performed before S104.

S105 (so that a group delay of a first rendered signal obtained through group delay filtering processing or a third rendered signal obtained through group delay filtering processing is a fixed value; and the audio rendering apparatus performs group delay filtering processing on the second rendered signal or the fourth rendered signal, so that a group delay of a second rendered signal obtained through group delay filtering processing or a fourth rendered signal obtained through group delay filtering processing is a fixed value.

Each of the first rendered signal, the second rendered signal, the third rendered signal, and the fourth rendered signal includes audio rendering signals of different frequencies (and the audio rendering signals of different frequencies have different delay time. In this case, when the first rendered signal and the third rendered signal are combined, or the second rendered signal and the fourth rendered signal are combined, an output combined signal has detrimental effect similar to group delay filtering (the group delay effect means that a sound waveform containing a complex structure is formed after sounds having different frequency waveforms or sounds having different phases are combined.

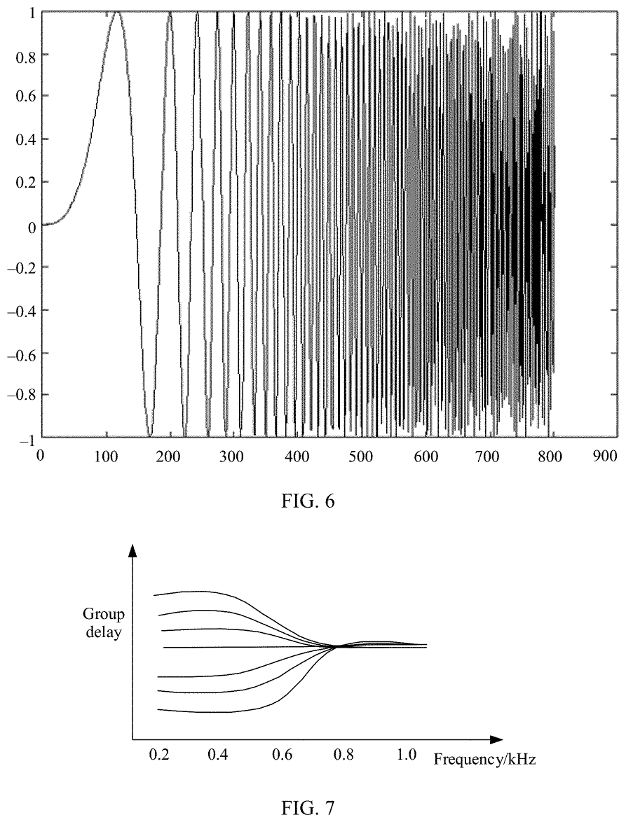

For example, refer to FIG. 6. FIG. 6 is a schematic diagram of an extreme case of detrimental effect of an audio signal. A horizontal axis represents a frequency, and a vertical axis represents an amplitude of the audio signal. As shown in FIG. 6, a signal amplitude corresponding to a frequency at a valley point of the audio signal is 0. In this case, it indicates that a signal at the frequency bin is missing.

To eliminate detrimental effect (destructive interference) of group delay effect, before combining the first rendered signal and the third rendered signal, the audio rendering apparatus may perform group delay filtering processing on the first rendered signal or the third rendered signal. For example, the audio rendering apparatus performs group delay filtering processing on the first rendered signal, so that a group delay of a first rendered signal obtained through group delay filtering processing is a fixed value; or performs group delay filtering processing on the third rendered signal, so that a group delay of a third rendered signal obtained through group delay filtering processing is a fixed value. This can eliminate group delay effect of a combined signal (that is, the first target rendered signal) obtained by combining a rendered signal obtained through group delay filtering processing and a rendered signal that does not undergo group delay filtering processing, where the rendered signal obtained through group delay filtering processing and the rendered signal that does not undergo group delay filtering processing are in the first rendered signal and the third rendered signal.

Similarly, before combining the second rendered signal and the fourth rendered signal, the audio rendering apparatus may perform group delay filtering processing on the second rendered signal or the fourth rendered signal. For example, the audio rendering apparatus performs group delay filtering processing on the second rendered signal, so that a group delay of a second rendered signal obtained through group delay filtering processing is a fixed value; or performs group delay filtering processing on the fourth rendered signal, so that a group delay of a fourth rendered signal obtained through group delay filtering processing is a fixed value. This can eliminate group delay effect of a combined signal (that is, the second target rendered signal) obtained by combining a rendered signal obtained through group delay filtering processing and a rendered signal that does not undergo group delay filtering processing, where the rendered signal obtained through group delay filtering processing and the rendered signal that does not undergo group delay filtering processing are in the second rendered signal and the fourth rendered signal.

The following provides descriptions by using an example in which the audio rendering apparatus separately performs group delay filtering processing on the third rendered signal and the fourth rendered signal, so that the group delay of each of the third rendered signal obtained through group delay filtering processing and the fourth rendered signal obtained through group delay filtering processing is a fixed value.

In an embodiment, the audio rendering apparatus may perform group delay filtering processing on the third rendered signal by using a preset gradual group delay filter, so that the group delay of the third rendered signal gradually becomes a fixed preset value. This eliminates detrimental effect of group delay effect generated when the third rendered signal obtained through group delay filtering processing and the first rendered signal that does not undergo group delay filtering processing are combined. Similarly, the audio rendering apparatus may perform group delay filtering processing on the fourth rendered signal by using a preset gradual group delay filter, so that the group delay of the fourth rendered signal gradually becomes a fixed preset value. This eliminates detrimental effect of group delay effect generated when the fourth rendered signal obtained through group delay filtering processing and the second rendered signal that does not undergo group delay filtering processing are combined. Herein, a value of the preset value is not limited in this embodiment of this application.

Refer to FIG. 7. FIG. 7 shows effect obtained after the audio rendering apparatus performs group delay filtering processing on the third rendered signal or the fourth rendered signal by using the preset gradual group delay filter. As shown in FIG. 7, after group delay filtering processing is performed on the third rendered signal or the fourth rendered signal, a group delay of each of the rendered signals is approximately a fixed preset value.

It may be understood that group delay filtering processing may alternatively be performed on the third rendered signal and the fourth rendered signal in another manner in this embodiment of this application. This is not limited in this embodiment of this application.

S106: The audio rendering apparatus combines the first rendered signal and the third rendered signal to obtain the first target rendered signal, and the audio rendering apparatus combines the second rendered signal and the fourth rendered signal to obtain the second target rendered signal.

In an embodiment the audio rendering apparatus may combine the first rendered signal and the third rendered signal to obtain the first target rendered signal, and the audio rendering apparatus may combine the second rendered signal and the fourth rendered signal to obtain the second target rendered signal.

In another embodiment, the audio rendering apparatus may perform fade-in processing on a signal in a transition band of the first rendered signal and a signal in a transition band of the second rendered signal, and separately perform fade-out processing on a signal in a transition band of the third rendered signal and a signal in a transition band of the fourth rendered signal. Then, the audio rendering apparatus may obtain a first combined signal based on a fade-in processed first rendered signal and a fade-out processed third rendered signal, and the audio rendering apparatus may obtain a second combined signal based on a fade-in processed second rendered signal and a fade-out processed fourth rendered signal. Herein, the first combined signal is a rendered signal that is in a transition band and that is output to the first position, and the second combined signal is a rendered signal that is in the transition band and that is output to the second position.

The transition band is a frequency band with a frequency range between a critical frequency between the high frequency band signal and the low frequency band signal minus a second bandwidth, and the critical frequency plus a first bandwidth. Herein, the first bandwidth and the second bandwidth may be the same, or may be different. This is not limited.

For example, if the critical frequency is f_{c}, and both the first bandwidth and the second bandwidth are fₓ, the frequency range of the transition band may be [f_{c}−−fₓ, f_{c}−+fₓ]

For example, f_{c} is 1500 Hz, and fₓ is 200 Hz. In this case, the transition band is [(1500−200) Hz, (1500+200) Hz], that is, [1300 Hz, 1700 Hz].

The audio rendering apparatus may perform fade-in processing on the signal in the transition band of the first rendered signal and the signal in the transition band of the second rendered signal by using a fade-in factor, and the audio rendering apparatus may perform fade-out processing on the signal in the transition band of the third rendered signal and the signal in the transition band of the fourth rendered signal by using a fade-out factor. It may be understood that the transition band may correspond to T combinations of a fade-in factor and a fade-out factor, where a sum of a fade-in factor and a fade-out factor that correspond to any one of the T combinations is 1, and T is a positive integer.

For example, the transition band includes T frequency bins, and each frequency bin may correspond to one combination of a fade-in factor and a fade-out factor. In other words, the T frequency bins correspond to T combinations of a fade-in factor and a fade-out factor. In this case, a sum of a fade-in factor corresponding to a t^{th} frequency bin and a fade-out factor corresponding to the t^{th} frequency bin is 1, where t is an integer, and 1≤t≤T.

For example, if T is 512, the fade-in factor of the transition band satisfies

$$Qr = ( \frac{512}{513} , \frac{511}{513} , … , \frac{2}{513} , \frac{1}{513} ) ,$$

and the fade-out factor of the transition band satisfies

$$Qc = ( \frac{1}{513} , \frac{2}{513} , … , \frac{511}{513} , \frac{512}{513} ) ,$$

combinations of 512 fade-in factors and 512 fade-out factors that correspond to the transition band are

$$( ( \frac{512}{513} , \frac{1}{513} ) , ( \frac{511}{513} , \frac{2}{513} ) , … , ( \frac{2}{513} , \frac{511}{513} ) , ( \frac{1}{513} , \frac{512}{513} ) ) .$$

It can be learned that Qᵣ+Q_{c}=(1, 1, . . . , 1, 1), the fade-in factors in the transition band are coefficients that gradually become 0 from 1, and the fade-out factors in the transition band are coefficients that gradually become 1 from 0.

Optionally, the audio rendering apparatus may obtain the first combined signal through calculation according to formula (1), and obtain the second combined signal through calculation according to formula (2):

Yᵣ₁=Y₁₀×Qᵣ+Y₃₀×Q_{c} Formula (1)

Yᵣ₂=Y₂₀×Qᵣ+Y₄₀×Q_{c} Formula (2)

Qᵣ is the fade-in factor, Q_{c} is the fade-out factor, Yᵣ₁ is the first combined signal, Y₁₀ is the signal in the transition band of the first rendered signal, Y₃₀ is the signal in the transition band of the third rendered signal, yᵣ₂ is the second combined signal, Y₂₀ is the signal in the transition band of the second rendered signal, and Y₄₀ is the signal in the transition band of the fourth rendered signal.

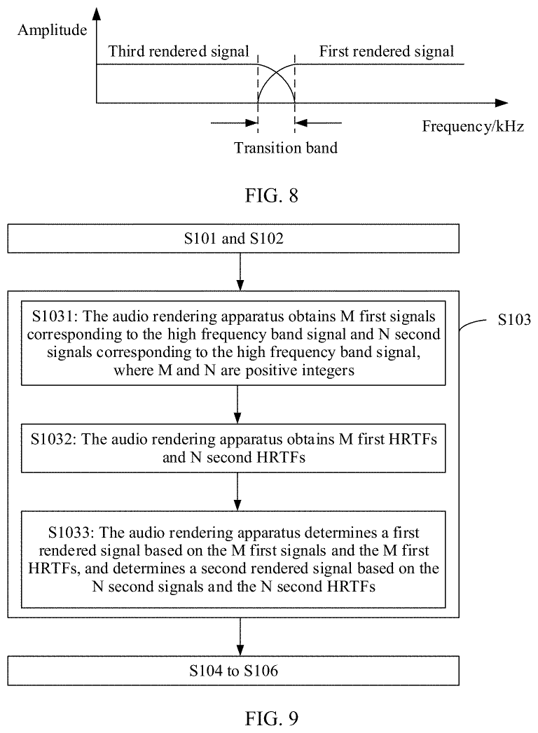

Refer to FIG. 8. FIG. 8 is a schematic diagram of performing fade-in processing on the first rendered signal and performing fade-out processing on the third rendered signal according to this embodiment of this application. A signal amplitude gradually changes from an amplitude of the third rendered signal to 0 after the signal in the transition band of the third rendered signal is processed by using the fade-out factor Q_{c}, and the signal amplitude gradually changes from 0 to an amplitude of the first rendered signal after the first rendered signal is processed by using the fade-in factor Qᵣ.

Similarly, the signal amplitude gradually changes from an amplitude of the fourth rendered signal to 0 after the signal in the transition band of the fourth rendered signal is processed by using the fade-out factor Q_{c}, and the signal amplitude gradually changes from 0 to an amplitude of the second rendered signal after the second rendered signal is processed by using the fade-in factor Qᵣ.

Then, the audio rendering apparatus may combine the first combined signal, a signal beyond the transition band of the first rendered signal, and a signal beyond the transition band of the third rendered signal to obtain the first target rendered signal; and the audio rendering apparatus may combine the second combined signal, a signal beyond the transition band of the second rendered signal, and a signal beyond the transition band of the fourth rendered signal to obtain the second target rendered signal. Herein, the first target rendered signal is a rendered signal output to the first position, and the second target rendered signal is a rendered signal output to the second position.

Optionally, the audio rendering apparatus may obtain a first target rendered signal SY₁ through calculation according to formula (3), and obtain a second target rendered signal SY₂ through calculation according to formula (4):

SY₁=Y₁₁+Yᵣ₁+Y₃₁ Formula (3)

SY₂=Y₂₁+Yᵣ₂+Y₄₁ Formula (4)

Y₁₁ is the signal beyond the transition band of the first rendered signal, Yᵣ₁ is the first combined signal, Y₃₁ is the signal beyond the transition band of the third rendered signal, Y₂₁ is the signal beyond the transition band of the second rendered signal, yᵣ₂ is the second combined signal, and Y₄₁ is the signal beyond the transition band of the fourth rendered signal.

In this case, the audio rendering apparatus divides the to-be-rendered audio signal into the high frequency band signal and the low frequency band signal, and renders the high frequency band signal by using the positions of the two ears of the listener as the sweet spots. This improves accuracy of an ILD of a rendered signal. The audio rendering apparatus renders the low frequency band signal by using the position of the center of the head of the listener as the sweet spot. This improves accuracy of an ITD of the rendered signal. Then, the audio rendering apparatus combines a rendered high frequency band signal (the first rendered signal and the second rendered signal) and a rendered low frequency band signal (the third rendered signal and the fourth rendered signal), to obtain the first target rendered signal and the second target rendered signal. The first target rendered signal and the second target rendered signal are a binaural rendered signal output to the listener. In this way, the binaural rendered signal obtained by using the audio rendering method provided in this embodiment of this application has a high-accuracy ITD and ILD. This improves accuracy of sound image localization performed based on the binaural rendered signal, reduces in-head effect of the binaural rendered signal, and increases a sound field width of the binaural rendered signal.

The following describes a process in which the audio rendering apparatus obtains the first rendered signal and the second rendered signal.

Refer to FIG. 9. S103 may further include the following operations.

S1031: The audio rendering apparatus obtains M first signals corresponding to the high frequency band signal and N second signals corresponding to the high frequency band signal, where M and N are positive integers.

Herein, the M first signals are M signals of M virtual speakers disposed in a sweet spot when a first position is a sweet spot, and the M first signals one-to-one correspond to the M virtual speakers. For example, M is 3. The three first signals may be a signal 1, a signal 2, and a signal 3, and the three virtual speakers may be a virtual speaker 1, a virtual speaker 2, and a virtual speaker 3. In this way, the signal 1 may correspond to the virtual speaker 1, the signal 2 may correspond to the virtual speaker 2, and the signal 3 may correspond to the virtual speaker 3.

The N second signals are N signals of N virtual speakers disposed in a sweet spot when a second position is a sweet spot, and the N virtual speakers one-to-one correspond to the N second signals. For example, N is 3. The three second signals may be a signal 1, a signal 2, and a signal 3, and the three virtual speakers may be a virtual speaker 1, a virtual speaker 2, and a virtual speaker 3. In this way, the signal 1 may correspond to the virtual speaker 1, the signal 2 may correspond to the virtual speaker 2, and the signal 3 may correspond to the virtual speaker 3.

The audio rendering apparatus may obtain, in any one of the following manners, the first signal and the second signal that correspond to the high frequency band signal.

Manner 1: The audio rendering apparatus processes the high frequency band signal to obtain the M first signals of the M virtual speakers, where the M virtual speakers are M virtual speakers disposed by using the first position as the sweet spot; and the audio rendering apparatus processes the high frequency band signal to obtain the N second signals of the N virtual speakers, where the N virtual speakers are N virtual speakers disposed by using the second position as the sweet spot.

Optionally, the audio rendering apparatus may obtain, through calculation based on the high frequency band signal in the obtained to-be-rendered audio signal and according to formula (5), the signals of the M virtual speaker disposed when the first position is the sweet spot, that is, the M first signals:

$${P}_{m} = \frac{1}{M} [ W ( \frac{1}{\sqrt{2}} ) + X ( cos ( {φ}_{m} ) cos ( {θ}_{m} ) ) + Y ( sin ( {φ}_{m} ) cos ( {θ}_{m} ) ) + Z ( sin ( {φ}_{m} ) ) ] \qquad Formula ( 5 )$$

M is a quantity of virtual speakers, and m represents an m^{th} virtual speaker in the M virtual speakers, where m is an integer, and 1≤m≤M; Pₘ represents a signal of the m^{th} virtual speaker; W, X, Y, and Z respectively represent four components of the high frequency band signal, where W represents an environment component, X represents an X-direction coordinate component, Y represents a Y-direction coordinate component, and Z represents a Z-direction coordinate component; φₘ represents a pitch angle of the m^{th} virtual speaker disposed when the sweet spot is the center; and θₘ represents an azimuth of the m^{th} virtual speaker disposed when the sweet spot is the center. It can be learned that a group of φₘ and θₘ may identify a position of a virtual speaker.

Optionally, the audio rendering apparatus may obtain, through calculation based on the high frequency band signal in the obtained to-be-rendered audio signal and according to formula (6), signals of the N virtual speaker disposed when the second position is the sweet spot, that is, N second signals:

$${P}_{n} = \frac{1}{N} [ W ( \frac{1}{\sqrt{2}} ) + \qquad Formula ( 6 )$$

$$X ( cos ( {φ}_{n} ) cos ( {θ}_{n} ) ) + Y ( sin ( {φ}_{n} ) cos ( {θ}_{n} ) ) + Z ( sin ( {φ}_{n} ) ) ]$$

N is a quantity of virtual speakers, and n represents an n^{th} virtual speaker in the N virtual speakers, where n is an integer, and 1≤n≤N; Pₙ represents a signal of the n^{th} virtual speaker; W, X, Y, and Z respectively represent four components of the high frequency band signal, where W represents an environment component, X represents an X-direction coordinate component, Y represents a Y-direction coordinate component, and Z represents a Z-direction coordinate component; φₙ represents a pitch angle of the n^{th} virtual speaker disposed when the sweet spot is the center; and θₙ represents an azimuth of the n^{th} virtual speaker disposed when the sweet spot is the center. It can be learned that a group of φₙ and θₙ may identify a position of a virtual speaker.

It is easy to understand that the signal of the virtual speaker is a sound source signal emitted by the virtual speaker, and a signal position of the virtual speaker is a position of the virtual speaker.

Manner 2: The audio rendering apparatus processes the high frequency band signal to obtain X initial signals corresponding to X virtual speakers, where the X initial signals one-to-one correspond to the X virtual speakers. The X virtual speakers are X virtual speakers disposed by using the position of the center of the head of the listener as the sweet spot, where X is a positive integer, and X=M=N.

For example, X is 3. The three initial signals may be an initial signal 1, an initial signal 2, and an initial signal 3, and the three virtual speakers may be a virtual speaker 1, a virtual speaker 2, and a virtual speaker 3. In this way, the initial signal 1 may correspond to the virtual speaker 1, the initial signal 2 may correspond to the virtual speaker 2, and the initial signal 3 may correspond to the virtual speaker 3.

Further, the audio rendering apparatus may separately rotate the X initial signals by a first angle to obtain the M first signals. The first angle is an included angle between a first connection line and a second connection line, the first connection line is a connection line between the position of the center of the head and any one of the X virtual speakers (which corresponds to a first virtual speaker in this embodiment of this application), and the second connection line is a connection line between the first virtual speaker and the first position.

Further, the audio rendering apparatus may separately rotate the X initial signals by a second angle to obtain the N second signals. The second angle may be an included angle between the first connection line and a third connection line, and the third connection line may be a connection line between the first virtual speaker and the second position. It may be understood that the first angle and the second angle may be the same or different. This is not limited.

Optionally, if the first angle is different from the second angle, the audio rendering apparatus may determine a first preset angle based on the first angle and the second angle, and separately rotate the X initial signals clockwise by the first preset angle to obtain the M first signals. Further, the audio rendering apparatus may separately rotate the X initial signals counterclockwise by the first preset angle, to obtain the N second signals. The clockwise rotation indicates rotation toward the first position, and the counterclockwise rotation indicates rotation toward the second position. For example, the first preset angle may be an average value of the first angle and the second angle. Certainly, this is not limited thereto.

Refer to FIG. 11. FIG. 11 schematically shows the foregoing first angle and second angle. As shown in FIG. 11, a virtual speaker 110 may be the foregoing first virtual speaker, and a connection line between the virtual speaker 110 and the position A of the center of the head of the listener is the foregoing first connection line. If a position B is the first position, and a position C is the second position, a connection line between the virtual speaker 110 and the first position B (for example, the position of the left ear of the listener) is the foregoing second connection line, and a connection line between the virtual speaker 110 and the second position C (for example, the position of the right ear of the listener) is the foregoing third connection line. In this case, an included angle between the first connection line and the second connection line is the foregoing first angle, and an included angle between the first connection line and the third connection line is the foregoing second angle.

As shown in FIG. 11, in a coordinate system in which the position of the center of the head of the listener is used as the origin, an included angle between the first connection line and an X axis is a₀, an included angle between the second connection line and the X axis is a₁, and an included angle between the third connection line and the X axis is a₂. In this case, the first angle may be |a₀−a₁|, and the second angle may be |a₀−a₂| Based on this, the foregoing first preset angle may be an average value of |a₀−a₁| and |a₀−a₂|, and certainly is not limited thereto.

S1032: The audio rendering apparatus obtains M first HRTFs and N second HRTFs.

The M first HRTFs are HRTFs of the first position that are when the first position is the sweet spot, and the M first HRTFs one-to-one correspond to the M first signals. For example, M is 3. The three first signals may be a signal 1, a signal 2, and a signal 3, and the three first HRTFs may be an HRTF 1, an HRTF 2, and an HRTF 3. In this way, the signal 1 may correspond to the HRTF 1, the signal 2 may correspond to the HRTF 2, and the signal 3 may correspond to the HRTF 3.

The N second HRTFs are HRTFs of the second position that are when the second position is the sweet spot, and the N second HRTFs one-to-one correspond to the N second signals. For example, N is 3. The three second signals may be a signal 1, a signal 2, and a signal 3, and the three second HRTFs may be an HRTF 1, an HRTF 2, and an HRTF 3. In this way, the signal 1 may correspond to the HRTF 1, the signal 2 may correspond to the HRTF 2, and the signal 3 may correspond to the HRTF 3.

The audio rendering apparatus may obtain the M first HRTFs and the N second HRTFs in any one of the following manners.

Manner 1: The audio rendering apparatus may obtain the M first HRTFs from a first correspondence library, and obtain the N second HRTFs from a second correspondence library.

Optionally, the audio rendering apparatus may measure in advance the M HRTFs of the first position based on the signals of the M virtual speakers (that is, the foregoing M first signals) by using the first position (for example, the first position may be the position of the left ear of the listener) as the sweet spot, and determine, as the first correspondence library, a position of each virtual speaker and a measured HRTF corresponding to the virtual speaker in the position. The audio rendering apparatus may further measure in advance the HRTFs of the second position based on the signals of the N virtual speakers (that is, the foregoing N second signals) by using the second position (for example, the second position may be the position of the right ear of the listener) as the sweet spot, and determine, as the second correspondence library, a position of each virtual speaker and a measured HRTF corresponding to the virtual speaker in the position. The first correspondence library and the second correspondence library may be a same database, or may be two independent databases. This is not limited.

The audio rendering apparatus may correspondingly determine the positions of the M virtual speakers when determining that the sweet spot is the first position. In this way, the audio rendering apparatus may obtain, from the first correspondence library and based on the determined positions of the M virtual speakers, the M HRTFs corresponding to the positions of the M virtual speakers. The M HRTFs are M first HRTFs corresponding to the signals of the M virtual speakers. Similarly, the audio rendering apparatus may further obtain, from the second correspondence library and based on the determined positions of the N virtual speakers, the N HRTFs corresponding to the positions of the N virtual speakers. The N HRTFs are N second HRTFs corresponding to the signals of the N virtual speakers.

For example, as shown in FIG. 4, after determining a position (including a pitch angle, an azimuth, and the like) of the virtual speaker 411, the audio rendering apparatus obtains, from the first correspondence library, an HRTF corresponding to the position of the virtual speaker 411, and uses the HRTF as a first HRTF corresponding to a signal of the virtual speaker 411. Similarly, after determining a position of the virtual speaker 421, the audio rendering apparatus obtains, from the second correspondence library, an HRTF corresponding to the position of the virtual speaker 421, and uses the HRTF as a second HRTF corresponding to a signal of the virtual speaker 421.

Manner 2: The audio rendering apparatus may obtain Y initial HRTFs from a third correspondence library, separately rotate the Y initial HRTFs by a third angle to obtain the M first HRTFs, and separately rotate the Y initial HRTFs by a fourth angle to obtain the N second HRTFs, where Y is an integer, and Y=M=N.

The Y initial HRTFs are HRTFs of the position of the center of the head of the listener that are measured based on signals of the Y virtual speakers by using the position of the center of the head as a sweet spot. Herein, the Y virtual speakers are Y virtual speaker disposed when the position of the center of the head is the sweet spot, and the Y initial HRTFs one-to-one correspond to the signals of the Y virtual speakers.

Optionally, the audio rendering apparatus may measure in advance an HRTF of the position of the center of the head by using the position of the center of the head of the listener as a sweet spot and based on the signal of the Y virtual speakers, and store, as the third correspondence library, a position of each virtual speaker and a measured HRTF corresponding to the virtual speaker in the position. The audio rendering apparatus may obtain, from the third correspondence library and based on the positions of the Y virtual speakers, the Y initial HRTFs corresponding to the positions of the Y virtual speakers.

Then, the audio rendering apparatus may separately rotate the obtained Y initial HRTFs by the third angle to obtain the M first HRTFs, and separately rotate the obtained Y initial HRTFs by the fourth angle to obtain the N second HRTFs.

The M first HRTFs one-to-one correspond to the M first signals, and the N second HRTFs one-to-one correspond to the N second signals.

For example, M is 3. The three first signals may be a signal 1, a signal 2, and a signal 3, and the three first HRTFs may be an HRTF 1, an HRTF 2, and an HRTF 3. In this way, the signal 1 may correspond to the HRTF 1, the signal 2 may correspond to the HRTF 2, and the signal 3 may correspond to the HRTF 3. For another example, N is 3. The three second signals may be a signal 1, a signal 2, and a signal 3, and the three second HRTFs may be an HRTF 1, an HRTF 2, and an HRTF 3. In this way, the signal 1 may correspond to the HRTF 1, the signal 2 may correspond to the HRTF 2, and the signal 3 may correspond to the HRTF 3.

The third angle may be an included angle between the third connection line and a fourth connection line, the third connection line is a connection line between the position of the center of the head and any one of the Y virtual speakers (which corresponds to the second virtual speaker in this embodiment of this application), and the fourth connection line is a connection line between the second virtual speaker and the first position. The fourth angle may be an included angle between the third connection line and a fifth connection line. Herein, the fifth connection line is a connection line between the second virtual speaker and the second position.

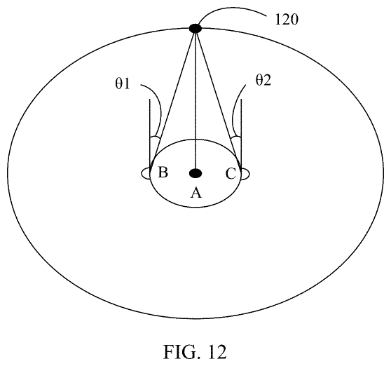

Refer to FIG. 12. FIG. 12 schematically shows a third angle θ1 and a fourth angle θ2. As shown in FIG. 12, a virtual speaker 120 may be the foregoing second virtual speaker, that is, any one of the Y virtual speakers disposed by using the position of the center of the head of the listener as the sweet spot. A connection line between the virtual speaker 120 and the position A of the center of the head of the listener is the foregoing third connection line. If a position B is the first position and a position C is the second position, a connection line between the virtual speaker 120 and the first position B (for example, the position of the left ear of the listener) is the foregoing fourth connection line, and a connection line between the virtual speaker 120 and the second position C (for example, the position of the right ear of the listener) is the foregoing fifth connection line. In this case, an included angle between the third connection line and the fourth connection line is the foregoing third angle, and an included angle between the third connection line and the fifth connection line is the foregoing fourth angle.

S1033: The audio rendering apparatus determines the first rendered signal based on the M first signals and the M first HRTFs, and determines the second rendered signal based on the N second signals and the N second HRTFs.

The audio rendering apparatus may convolve the determined M first signals respectively with the M first HRTFs to obtain the M rendered signals. Then, the audio rendering apparatus combines the M rendered signals to obtain the first rendered signal. Similarly, the audio rendering apparatus may convolve the determined N second signals respectively with the N second HRTFs to obtain the N rendered signals. Then, the audio rendering apparatus combines the N rendered signals to obtain the second rendered signal.

Optionally, the audio rendering apparatus may obtain the first rendered signal Y₁ through calculation according to formula (7), and obtain the second rendered signal Y₂ through calculation according to formula (8):

Y₁=Σₘ₌₀^{M}(Pₘ⊗HRTFₘ) Formula 7

Y₂=Σₙ₌₀^{N}(Pₙ⊗HRTFₙ) Formula 8

Pₘ represents the signal of the m^{th} virtual speaker, that is, the m^{th} first signal; ⊗ is a convolutional symbol; HRTFₘ represents a first HRTF corresponding to the signal of the m^{th} virtual speaker; Pₙ represents the signal of an n^{th} virtual speaker, that is, an n^{th} second signal; and HRTFₙ represents a second HRTF corresponding to a signal of the n^{th} virtual speaker.

It should be understood that the first rendered signal Y₁ includes a signal in a transition band Y₁₀ of the first rendered signal and a signal beyond the transition band Y₁₁ of the first rendered signal, that is, Y₁=Y₁₀+Y₁₁. Similarly, the second rendered signal Y₂ includes a signal in a transition band Y₂₀ of the second rendered signal and a signal beyond the transition band Y₂₁ of the second rendered signal, that is, Y₂=Y₂₉+Y₂₁.

It may be understood that the first signal is a signal of a virtual speaker disposed when the first position as the sweet spot. Therefore, the first rendered signal obtained through calculation based on the first signal may be a rendered signal output to the first position. The second signal is a signal of a virtual speaker disposed when the second position is the sweet spot. Therefore, the second rendered signal obtained through calculation based on the second signal may be a rendered signal output to the second position.

The following describes a process in which the audio rendering apparatus obtains the third rendered signal and the fourth rendered signal.

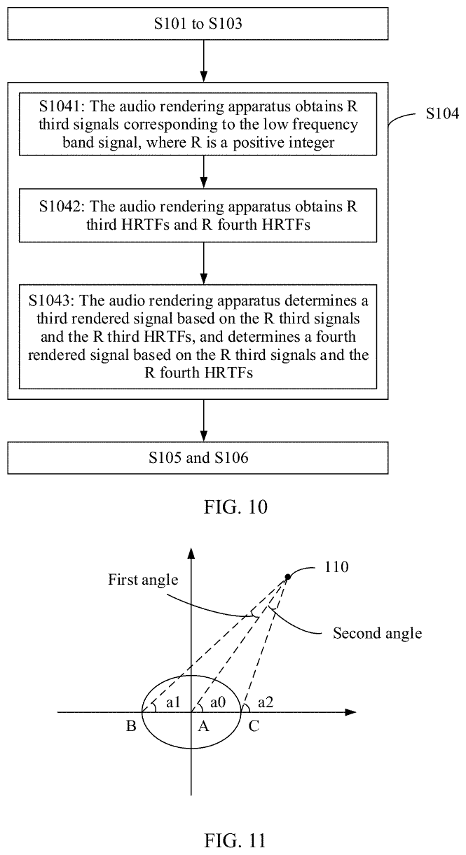

Refer to FIG. 10. S104 may further include the following operations.

S1041: The audio rendering apparatus obtains R third signals corresponding to the low frequency band signal, where R is a positive integer.

Herein, the R third signals are signals of R virtual speakers, and the R virtual speakers are R virtual speakers corresponding to the sweet spot when the position of the center of the head of the listener is the sweet spot. The R virtual speakers one-to-one correspond to the R third signals. For example, R is 3. The three third signals may be a signal 1, a signal 2, and a signal 3, and the three virtual speakers may be a virtual speaker 1, a virtual speaker 2, and a virtual speaker 3. In this way, the signal 1 may correspond to the virtual speaker 1, the signal 2 may correspond to the virtual speaker 2, and the signal 3 may correspond to the virtual speaker 3.

Optionally, the audio rendering apparatus may obtain, through calculation based on the low frequency band signal in the obtained to-be-rendered audio signal and according to formula (9), signals of R virtual speaker disposed when the position of the center of the head of the listener is the sweet spot, that is, the R third signals:

$${P}_{r} = \frac{1}{R} [ W ( \frac{1}{\sqrt{2}} ) + \qquad Formula ( 9 )$$

$$X ( cos ( {φ}_{r} ) cos ( {θ}_{r} ) ) + Y ( sin ( {φ}_{r} ) cos ( {θ}_{r} ) ) + Z ( sin ( {φ}_{r} ) ) ]$$

R is a quantity of virtual speakers, and r represents an r^{th} virtual speaker in the R virtual speakers, where r is an integer, and 1≤r≤R; Pᵣ represents a signal of the r^{th} virtual speaker; W, X, Y, and Z respectively represent four components of the low frequency band signal, where W represents an environment component, X represents an X-direction coordinate component, Y represents a Y-direction coordinate component, and Z represents a Z-direction coordinate component; and φᵣ represents a pitch angle of the r^{th} virtual speaker disposed when the sweet spot is the center, and θᵣ represents an azimuth of the r^{th} virtual speaker disposed when the sweet spot is the center. It can be learned that a group of φᵣ and θᵣ may identify a position of a virtual speaker.

It is easy to understand that the signal of the virtual speaker is a sound source signal emitted by the virtual speaker, and a signal position of the virtual speaker is a position of the virtual speaker.

S1042: The audio rendering apparatus obtains R third HRTFs and R fourth HRTFs.

The R third HRTFs are HRTFs of the first position that are measured based on the R third signals by using the position of the center of the head of the listener as the sweet spot, and the R third HRTFs one-to-one correspond to the R third signals. For example, R is 3. The three third signals may be a signal 1, a signal 2, and a signal 3, and the three third HRTFs may be an HRTF 1, an HRTF 2, and an HRTF 3. In this way, the signal 1 may correspond to the HRTF 1, the signal 2 may correspond to the HRTF 2, and the signal 3 may correspond to the HRTF 3.

The R fourth HRTFs are HRTFs of the second position that are measured based on the R third signals by using the position of the center of the head of the listener as the sweet spot, and the R fourth HRTFs one-to-one correspond to the R third signals. For example, R is 3. The three third signals may be a signal 1, a signal 2, and a signal 3, and the three third HRTFs may be an HRTF 1, an HRTF 2, and an HRTF 3. In this way, the signal 1 may correspond to the HRTF 1, the signal 2 may correspond to the HRTF 2, and the signal 3 may correspond to the HRTF 3.

Optionally, the audio rendering apparatus may measure in advance an HRTF of a first position (for example, the first position may be the position of the left ear of the listener) based on signals of the R virtual speakers (that is, the R third signals) by using the position of the center of the head of the listener as the sweet spot, and store, as a fourth correspondence library, a position of each virtual speaker and a measured HRTF corresponding to the virtual speaker in the position. The audio rendering apparatus may further measure in advance an HRTF of a second position (for example, the second position may be the position of the right ear of the listener) based on the signals of the R virtual speakers (that is, the R third signals) by using the position of the center of the head of the listener as the sweet spot, and store, as a fifth correspondence library, a position of each virtual speaker and a measured HRTF corresponding to the virtual speaker in the position. Herein, the fourth correspondence library and the fifth correspondence library may be a same database, or may be two independent databases. This is not limited.

The audio rendering apparatus may correspondingly determine positions of the R virtual speakers when determining the sweet spot as the center of the head of the listener. In this way, the audio rendering apparatus may obtain, from the fourth correspondence library and based on the determined positions of the R virtual speakers, the R HRTFs corresponding to the positions of the R virtual speakers. The R HRTFs are third HRTFs corresponding to the signals of the R virtual speakers. Similarly, the audio rendering apparatus may further obtain, from the fifth correspondence library and based on the determined positions of the R virtual speakers, the R HRTFs corresponding to the positions of the R virtual speakers. The R HRTFs are fourth HRTFs corresponding to the signals of the R virtual speakers.

For example, as shown in FIG. 5, after determining a position (including a pitch angle, an azimuth, and the like) of the virtual speaker 51, the audio rendering apparatus obtains, from the fourth correspondence library, an HRTF corresponding to the position of the virtual speaker 51, and uses the HRTF as a third HRTF corresponding to a signal of the virtual speaker 51. After determining the position of the virtual speaker 51, the audio rendering apparatus further obtains, from the fifth correspondence library, the HRTF corresponding to the position of the virtual speaker 51, and uses the HRTF as a fourth HRTF corresponding to the signal of the virtual speaker 51.

S1043: The audio rendering apparatus determines the third rendered signal based on the R third signals and the R third HRTFs, and determines the fourth rendered signal based on the R fourth signals and the R fourth HRTFs.

The audio rendering apparatus may convolve the determined R third signals respectively with the R third HRTFs to obtain R rendered signals. Then, the audio rendering apparatus combines the R rendered signals to obtain the third rendered signal. Similarly, the audio rendering apparatus may convolve the determined R third signals respectively with the R fourth HRTFs to obtain R rendered signals. Then, the audio rendering apparatus combines the R rendered signals to obtain the fourth rendered signal.

Optionally, the audio rendering apparatus may obtain the third rendered signal Y₃ through calculation according to formula (10), and obtain the fourth rendered signal Y₄ through calculation according to formula (11):

Y₃=Σᵣ₌₀^{R}(Pᵣ⊗HRTF_{r_1}) Formula 10

Y₄=Σᵣ₌₀^{R}(Pᵣ⊗HRTF_{r_2}) Formula 11

Pᵣ represents a signal of an r^{th} virtual speaker, that is, the r^{th} third signal, HRTF_{r_1} represents a third HRTF corresponding to the signal of the r^{th} virtual speaker, and HRTF_{r_2} represents a fourth HRTF corresponding to the signal of the r^{th} virtual speaker.

It should be understood that the third rendered signal Y₃ includes a signal in a transition band Y₃₀ of the third rendered signal and a signal beyond the transition band Y₃₁ of the third rendered signal, that is, Y₃=Y₃₀+Y₃₁. Similarly, the fourth rendered signal Y₄ includes a signal in a transition band Y₄₀ of the fourth rendered signal and a signal beyond the transition band Y₄₁ of the fourth rendered signal, that is, Y₄=Y₄₀+Y₄₁.

It may be understood that the R third HRTFs for determining the third rendered signal are measured HRTFs of the first position. Therefore, the third rendered signal may be a rendered signal output to the first position. The fourth HRTFs for determining the fourth rendered signal are measured HRTFs of the second position. Therefore, the fourth rendered signal may be a rendered signal output to the second position.

In conclusion, this embodiment of this application provides the audio rendering method. In the method, the audio rendering apparatus divides the to-be-rendered audio signal into the high frequency band signal and the low frequency band signal, and renders the high frequency band signal by using the positions of the two ears of the listener as the sweet spots. This improves accuracy of an ILD of a rendered signal. The audio rendering apparatus renders the low frequency band signal by using the position of the center of the head of the listener as the sweet spot. This improves accuracy of an ITD of the rendered signal. Then, the audio rendering apparatus combines a rendered high frequency band signal (the first rendered signal and the second rendered signal) and a rendered low frequency band signal (the third rendered signal and the fourth rendered signal), to obtain the first target rendered signal and the second target rendered signal. The first target rendered signal and the second target rendered signal are a binaural rendered signal output to the listener. In this way, the binaural rendered signal obtained by using the audio rendering method provided in this embodiment of this application has a high-accuracy ITD and ILD. This improves accuracy of sound image localization performed based on the binaural rendered signal, reduces in-head effect of the binaural rendered signal, and increases a sound field width of the binaural rendered signal.

### Embodiment 2

In this embodiment, an audio rendering apparatus transforms an HRTF for processing a to-be-rendered audio signal to a to-be-rendered audio signal domain, and renders the to-be-rendered audio signal in the to-be-rendered audio signal domain.

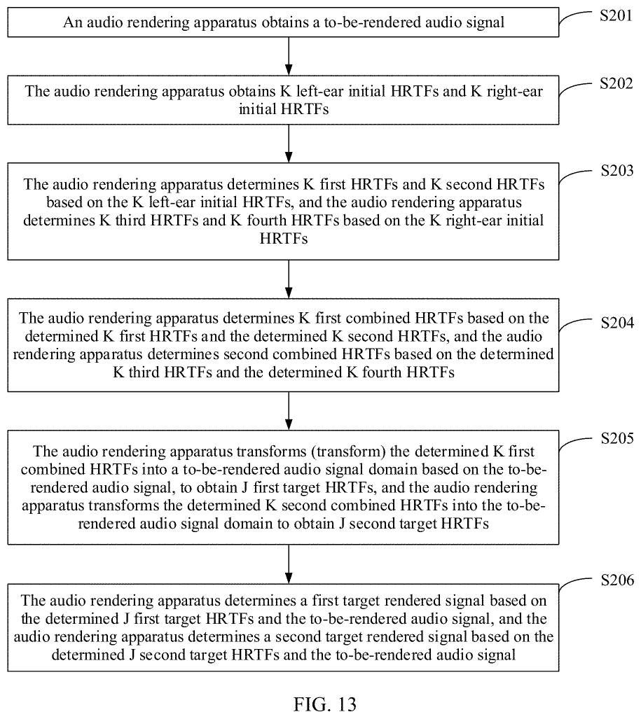

Refer to FIG. 13. FIG. 13 is a schematic flowchart of another audio rendering method according to this embodiment of this application. The method may include the following operations.

S201: The audio rendering apparatus obtains the to-be-rendered audio signal.

For descriptions of obtaining the to-be-rendered audio signal by the audio rendering apparatus, refer to the descriptions in S101. Details are not described herein again.

The to-be-rendered audio signal includes J channel signals, where J is a positive integer. For example, J may be an integer greater than or equal to 2.

S202: The audio rendering apparatus obtains K left-ear initial HRTFs and K right-ear initial HRTFs.

Herein, the K left-ear initial HRTFs may be left-ear HRTFs measured based on signals of K virtual speakers by using the position of the center of the head of a listener as a sweet spot. The K left-ear initial HRTFs one-to-one correspond to signals of K virtual speakers. The left-ear initial HRTF is a left-ear HRTF. A rendered signal output to the left ear of the listener may be obtained after the to-be-rendered audio signal is processed by using the left-ear HRTF. K is a positive integer. For example, K may be an integer greater than or equal to 3.

The K right-ear initial HRTFs may be right-ear HRTFs measured based on the signals of the K virtual speakers by using the position of the center of the head of the listener as the sweet spot. The K right-ear initial HRTFs one-to-one correspond to the signals of the K virtual speakers. The right-ear initial HRTF is a right-ear HRTF. A rendered signal output to the right ear of the listener may be obtained after the to-be-rendered audio signal is processed by using the right-ear HRTF.

The K virtual speakers are K virtual speakers disposed by using the position of the center of the head of the listener as the sweet spot.

For a process in which the audio rendering apparatus obtains the K left-ear initial HRTFs and the K right-ear initial HRTFs, refer to the descriptions of obtaining the R third HRTFs and the R fourth HRTFs in S1042. Details are not described herein again.

S203: The audio rendering apparatus determines K first HRTFs and K second HRTFs based on the K left-ear initial HRTFs, and the audio rendering apparatus determines K third HRTFs and K fourth HRTFs based on the K right-ear initial HRTFs.

The K first HRTFs may be low frequency band HRTFs. The low frequency band HRTF may be a left-ear HRTF for processing a low frequency band signal in the to-be-rendered audio signal. The K second HRTFs may be high frequency band HRTFs. The high frequency band HRTF may be a left-ear HRTF for processing a high frequency band signal in the to-be-rendered audio signal.

The K third HRTFs may be a low frequency band HRTF. The low frequency band HRTF may be a right-ear HRTF for processing the low frequency band signal in the to-be-rendered audio signal. The K fourth HRTFs may be high frequency band HRTFs. The high frequency band HRTF may be a right-ear HRTF for processing the high frequency band signal in the to-be-rendered audio signal.

It may be understood that a frequency range of the low frequency band signal and a frequency range of the high frequency band signal may cover a frequency range of the to-be-rendered audio signal.

The audio rendering apparatus may obtain the K first HRTFs, the K second HRTFs, the K third HRTFs, and the K fourth HRTFs in any one of the following embodiments.

In a first embodiment, the audio rendering apparatus may separately perform low-pass filtering processing on the K left-ear initial HRTFs to obtain the K first HRTFs. The audio rendering apparatus may further separately perform high-pass filtering processing on the K left-ear initial HRTFs to obtain the K second HRTFs.

The audio rendering apparatus may separately perform low-pass filtering processing on the K right-ear initial HRTFs to obtain the K third HRTFs. The audio rendering apparatus may further separately perform high-pass filtering processing on the K right-ear initial HRTFs to obtain the K fourth HRTFs.

Optionally, the audio rendering apparatus may separately perform low-pass filtering processing on the K left-ear initial HRTFs by using a low-pass filter. The audio rendering apparatus may further separately perform high-pass filtering processing on the K left-ear initial HRTFs by using a high-pass filter.

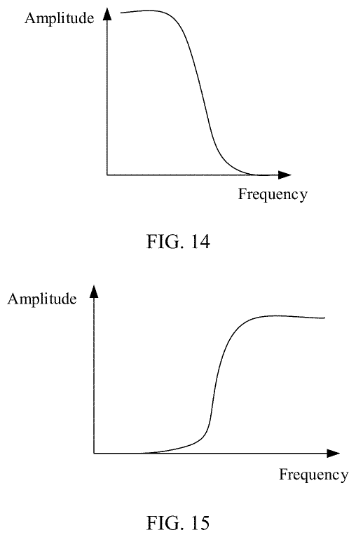

For example, the audio rendering apparatus may filter out a high-frequency part of a k^{th} left-ear initial HRTF in the K left-ear initial HRTFs by using a low-pass filter, to obtain a k^{th} first HRTF corresponding to the k^{th} left-ear initial HRTF, as shown in FIG. 14. Herein, k is a positive integer, and 1≤k≤K.

For another example, the audio rendering apparatus may filter out a low-frequency part of a k^{th} left-ear initial HRTF in the K left-ear initial HRTFs by using a high-pass filter, to obtain a k^{th} second HRTF corresponding to the k^{th} left-ear initial HRTF, as shown in FIG. 15.

Similarly, the audio rendering apparatus may separately perform low-pass filtering processing on the K right-ear initial HRTFs by using a low-pass filter, to obtain the K third HRTFs. The audio rendering apparatus may further separately perform high-pass filtering processing on the K right-ear initial HRTFs by using a high-pass filter, to obtain the K fourth HRTFs. Details are not described herein again.

In a second embodiment, the audio rendering apparatus may separately perform low-pass filtering processing on the K left-ear initial HRTFs to obtain the K first initial HRTFs. The audio rendering apparatus may further separately perform high-pass filtering processing on the K left-ear initial HRTFs to obtain the K second initial HRTFs. Then, the audio rendering apparatus performs delay processing on the K first initial HRTFs or the K second initial HRTFs to obtain the K first HRTFs or the K second HRTFs. The K first HRTFs may be obtained if the audio rendering apparatus performs delay processing on the K first initial HRTFs. In this case, the K second initial HRTFs are the K second HRTFs. The K second HRTFs may be obtained if the audio rendering apparatus performs delay processing on the K second initial HRTFs. In this case, the K first initial HRTFs are the K first HRTFs.

It should be noted that the audio rendering apparatus does not perform delay processing on the K second initial HRTFs if performing delay processing on the K first initial HRTFs. The audio rendering apparatus does not perform delay processing on the K first initial HRTFs if performing delay processing on the K second initial HRTFs. That is, at least one of a k^{th} first HRTF in the K first HRTFs and a k^{th} second HRTF in the K second HRTFs is obtained through delay processing. In this way, detrimental effect generated when the k^{th} first HRTF and the k^{th} second HRTF are combined can be eliminated. Herein, for related descriptions of the detrimental effect, refer to the descriptions in S105. Details are not described herein again.

The audio rendering apparatus may further separately perform low-pass filtering processing on the K right-ear initial HRTFs to obtain K third initial HRTFs. The audio rendering apparatus may further separately perform high-pass filtering processing on the K right-ear initial HRTFs to obtain K fourth initial HRTFs. Then, the audio rendering apparatus performs delay processing on the K third initial HRTFs or the K fourth initial HRTFs to obtain K third HRTFs or K fourth HRTFs. The K third HRTFs may be obtained if the audio rendering apparatus performs delay processing on the K third initial HRTFs. In this case, the K fourth initial HRTFs are the K fourth HRTFs. The K fourth HRTFs may be obtained if the audio rendering apparatus performs delay processing on the K fourth initial HRTFs. In this case, the K third initial HRTFs are the K third HRTFs.

It should be noted that the audio rendering apparatus does not perform delay processing on the K fourth initial HRTFs if performing delay processing on the K third initial HRTFs. The audio rendering apparatus does not perform delay processing on the K third initial HRTFs if performing delay processing on the K fourth initial HRTFs. In other words, at least one of a k^{th} third HRTF in the K third HRTFs and a k^{th} fourth HRTF in the K fourth HRTFs is obtained through delay processing. In this way, detrimental effect generated when the k^{th} third HRTF and the k^{th} fourth HRTF are combined can be eliminated.

The audio rendering apparatus may perform delay processing on the K first initial HRTFs, so that a group delay of processed K first initial HRTFs is a fixed value, that is, a group delay of the K first HRTFs is the fixed value. Alternatively, the audio rendering apparatus may perform delay processing on the K second initial HRTFs, so that a group delay of processed K second initial HRTFs is a fixed value, that is, a group delay of the K second HRTFs is the fixed value.

It should be noted that the audio rendering apparatus sets a different delay value for each first initial HRTF when performing delay processing on the K first initial HRTFs, so that a group delay of delay processed K first initial HRTFs is a fixed value, that is, a group delay of the K first HRTFs is the fixed value. Similarly, the audio rendering apparatus sets a different delay value for each second initial HRTF when performing delay processing on the K second initial HRTFs, so that a group delay of delay processed K second initial HRTFs is a fixed value, that is, a group delay of the K second HRTFs is the fixed value.

Similarly, the audio rendering apparatus may perform delay processing on the K third initial HRTFs, so that a group delay of processed K third initial HRTFs is a fixed value, that is, a group delay of the K third HRTFs is the fixed value. Alternatively, the audio rendering apparatus may perform delay processing on the K fourth initial HRTFs, so that a group delay of processed K fourth initial HRTFs is a fixed value, that is, a group delay of the K fourth HRTFs is the fixed value.

It should be noted that the audio rendering apparatus sets a different delay value for each third initial HRTF when performing delay processing on the K third initial HRTFs, a group delay of delay processed K third initial HRTFs is a fixed value, that is, a group delay of the K third HRTFs is the fixed value. Similarly, the audio rendering apparatus sets a different delay value for each fourth initial HRTF when performing delay processing on the K fourth initial HRTFs, so that a group delay of delay processed K fourth initial HRTFs is a fixed value, that is, a group delay of the K fourth HRTFs is the fixed value.

In a third possible manner, the audio rendering apparatus may separately perform delay processing on the K left-ear initial HRTFs. Then, the audio rendering apparatus may perform low-pass filtering processing on K left-ear initial HRTFs that do not undergo delay processing, to obtain the K first HRTFs, and perform high-pass filtering processing on K left-ear initial HRTFs that do not undergo delay processing, to obtain the K second HRTFs. Alternatively, the audio rendering apparatus may perform low-pass filtering processing on delay processed K left-ear initial HRTFs, to obtain the K first HRTFs, and perform high-pass filtering processing on K left-ear initial HRTFs that do not undergo delay processing, to obtain the K second HRTFs.

That is, delay processing is performed on at least one of a k^{th} first HRTF in the K first HRTFs and a k^{th} second HRTF in the K second HRTFs. In this way, detrimental effect generated when the k^{th} first HRTF and the k^{th} second HRTF are combined can be eliminated. For related descriptions of delay processing and the detrimental effect, refer to the descriptions of delay processing and the detrimental effect in the foregoing second embodiment. Details are not described herein again.

The audio rendering apparatus may separately perform delay processing on the K right-ear initial HRTFs. Then, the audio rendering apparatus may perform low-pass filtering processing on K right-ear initial HRTFs that do not undergo delay processing, to obtain the K third HRTFs, and perform high-pass filtering processing on delay processed K right-ear initial HRTFs, to obtain the K fourth HRTFs. Alternatively, the audio rendering apparatus may perform low-pass filtering processing on delay processed K right-ear initial HRTFs, to obtain the K third HRTFs, and perform high-pass filtering processing on K right-ear initial HRTFs that do not undergo delay processing, to obtain the K fourth HRTFs.

In other words, at least one of a k^{th} third HRTF in the K third HRTFs and a k^{th} fourth HRTF in the K fourth HRTFs is obtained through delay processing. In this way, detrimental effect generated when the k^{th} third HRTF and the k^{th} fourth HRTF are combined can be eliminated.

Optionally, based on the foregoing several embodiments, the audio rendering apparatus may further perform delay processing on each of the following: the K first HRTFs, the K second HRTFs, the K third HRTFs, and the K fourth HRTFs. In addition, the audio rendering apparatus sets a same delay value for each to-be-processed HRTF. In this case, a rendered signal with a smooth waveform may be obtained after an HRTF obtained by performing delay processing based on the same delay value is applied to the to-be-rendered audio signal. This improves quality of the rendered signal.

It can be learned that the first HRTF and the second HRTF are determined based on a same left-ear HRTF (that is, the foregoing left-ear initial HRTF), and the third HRTF and the fourth HRTF are determined based on a same right-ear HRTF (that is, the foregoing right-ear initial HRTF).

S204: The audio rendering apparatus determines K first combined HRTFs based on the determined K first HRTFs and the determined K second HRTFs, and the audio rendering apparatus determines K second combined HRTFs based on the determined K third HRTFs and the determined K fourth HRTFs.

The K first combined HRTFs are left-ear HRTFs for processing the to-be-rendered audio signal, and the K second combined HRTFs are right-ear HRTFs for processing the to-be-rendered audio signal.

The audio rendering apparatus combines the determined K first HRTFs and corresponding second HRTFs in the K second HRTFs to obtain the K first combined HRTFs, and the audio rendering apparatus combines the determined K third HRTFs and corresponding fourth HRTFs in the K fourth HRTFs to obtain the K second combined HRTFs.

A first HRTF and a second HRTF that are obtained based on a same left-ear initial HRTF correspond to each other, and a third HRTF and a fourth HRTF that are obtained based on a same right-ear initial HRTF correspond to each other. Because the first HRTF and the second HRTF are obtained based on the same left-ear initial HRTF, accuracy of the first combined HRTF obtained based on the first HRTF and the second HRTF can be higher. This can improve accuracy of an ITD of a left-ear rendered signal. Similarly, because the third HRTF and the fourth HRTF are obtained based on the same right-ear initial HRTF, accuracy of the second combined HRTF obtained based on the third HRTF and the fourth HRTF can be higher. This can improve accuracy of an ITD of a right-ear rendered signal.

For example, the k^{th} first HRTF and the k^{th} second HRTF may be obtained based on the k^{th} left-ear initial HRTF in the K left-ear initial HRTFs. The k^{th} first HRTF and the k^{th} second HRTF are combined to obtain a k^{th} first combined HRTF.

For another example, the k^{th} third HRTF and the k^{th} fourth HRTF may be obtained based on the k^{th} right-ear initial HRTF in the K right-ear initial HRTFs. The k^{th} third HRTF and the k^{th} fourth HRTF are combined to obtain a k^{th} second combined HRTF.

It may be understood that a time sequence of performing operation S201 and operations S202 to S204 is not limited in this embodiment of this application. For example, operation S201 and operations S202 to S204 may be simultaneously performed. Alternatively, operation S201 may be performed before operations S202 to S204. This is not limited.

S205: The audio rendering apparatus transforms the determined K first combined HRTFs into a to-be-rendered audio signal domain based on the to-be-rendered audio signal, to obtain J first target HRTFs, and the audio rendering apparatus transforms the determined K second combined HRTFs into the to-be-rendered audio signal domain to obtain J second target HRTFs.

J may be greater than K, may be equal to K, or may be less than K. This is not limited.

The K first combined HRTFs are HRTFs measured based on signals of K virtual speakers that are disposed by using the position of the left ear of the listener as a sweet spot, that is, the K first combined HRTFs one-to-one correspond to the signals of the K virtual speakers. Therefore, the audio rendering apparatus needs to transform the first combined HRTF into the to-be-rendered audio signal domain to obtain HRTFs that one-to-one correspond to the J channel signals in the to-be-rendered audio signal.

Similarly, the K second combined HRTFs are HRTFs measured based on signals of K virtual speakers that are disposed by using the position of the right ear of the listener as a sweet spot, that is, the signals of the K second combined HRTFs one-to-one correspond to the K virtual speakers. Therefore, the audio rendering apparatus needs to transform the second combined HRTF into the to-be-rendered audio signal domain to obtain HRTFs that one-to-one correspond to the J channel signals in the to-be-rendered audio signal.

The audio rendering apparatus may transform the determined K first combined HRTFs into the to-be-rendered audio signal domain based on the to-be-rendered audio signal according to a preset algorithm, to obtain the J first target HRTFs. The J first target HRTFs are left-ear HRTFs in the to-be-rendered audio signal domain, and the J first target HRTFs one-to-one correspond to the J channel signals.

The audio rendering apparatus may transform the determined K second combined HRTFs into the to-be-rendered audio signal domain based on the to-be-rendered audio signal according to a preset algorithm, to obtain the J second target HRTFs. The J second target HRTFs are right-ear HRTFs in the to-be-rendered audio signal domain, and the J second target HRTFs one-to-one correspond to the J channel signals.

Optionally, the preset algorithm may be a matrix transformation algorithm. The following describes the matrix transformation algorithm by using a specific example.

Optionally, the audio rendering apparatus may transform the K first combined HRTFs into the to-be-rendered audio signal domain according to formula (12), to obtain the J first target HRTFs:

$$( \begin{matrix}{y}_{1} & … & {y}_{j}\end{matrix} ) = ( \begin{matrix}{x}_{1} & … & {x}_{k}\end{matrix} ) \times ( \begin{matrix}{q}_{11} & … & {q}_{1 j} \\ ⋮ & ⋱ & ⋮ \\ {q}_{k 1} & … & {q}_{kj}\end{matrix} ) \qquad Formula ( 12 )$$

yⱼ represents a first target HRTF corresponding to a j^{th} channel signal, and the first target HRTF corresponding to the j^{th} channel signal is for processing the j^{th} channel signal in the J channel signals, where j is a positive integer, and 1≤j≤J; xₖ represents the k^{th} first combined HRTF in the K first combined HRTFs; q₁₁ . . . qₖ₁ each represent a domain transformation coefficient corresponding to a 1^{st} channel signal in the J channel signals; and q₁ⱼ . . . qₖⱼ each represent a domain transformation coefficient corresponding to the j^{th} channel signal in the J channel signals. The domain transformation coefficient may be obtained by multiplying a channel signal by K different weight coefficients. For example, q₁₁ . . . qₖ₁ are obtained by multiplying the 1^{st} channel signal by the K different weight coefficients. It is easy to learn that the J first target HRTFs one-to-one correspond to the J channel signals.

Similarly, the audio rendering apparatus may transform the K second combined HRTFs into the to-be-rendered audio signal domain according to formula (12), to obtain the J second target HRTFs. In this case, yⱼ represents a second target HRTF corresponding to the j^{th} channel signal, and the second target HRTF corresponding to the j^{th} channel signal is for processing the j^{th} channel signal in the J channel signals; xₖ represents the k^{th} second combined HRTF in K second combined HRTFs; q₁₁ . . . qₖ₁ each represent a domain transformation coefficient corresponding to a 1^{st} channel signal in the J channel signals; and q₁ⱼ . . . qₖⱼ each represent a domain transformation coefficient corresponding to the j^{th} channel signal in the J channel signals. The domain transformation coefficient may be obtained by multiplying a channel signal by K different weight coefficients. For example, q₁₁ . . . qₖ₁ are obtained by multiplying the 1^{st} channel signal by the K different weight coefficients. It is easy to learn that the J second target HRTFs one-to-one correspond to the J channel signals.

S206: The audio rendering apparatus determines a first target rendered signal based on the determined J first target HRTFs and the to-be-rendered audio signal, and the audio rendering apparatus determines a second target rendered signal based on the determined J second target HRTFs and the to-be-rendered audio signal.

The audio rendering apparatus convolves each of the J first target HRTFs with a corresponding channel signal in the J channel signals included in the to-be-rendered audio signal, to obtain rendered signals corresponding to the J channels. Then, the audio rendering apparatus combines the rendered signals corresponding to the J channels, to obtain the first target rendered signal. Herein, the first target rendered signal is a rendered signal output to the left ear of the listener.

For example, if a channel signal corresponding to a j^{th} first target HRTF in the J first target HRTFs is the j^{th} channel signal in the J channel signals, the audio rendering apparatus convolves the j^{th} first target HRTF with the j^{th} channel signal, to obtain a rendered signal of the j^{th} channel signal.

Similarly, the audio rendering apparatus convolves each of the J second target HRTFs with a corresponding channel signal in the J channel signals included in the to-be-rendered audio signal, to obtain rendered signals corresponding to the J channel signals. Then, the audio rendering apparatus combines the rendered signals corresponding to the J channel signals to obtain the second target rendered signal. Herein, the second target rendered signal is a rendered signal output to the right ear of the listener.

For example, if a channel signal corresponding to a j^{th} second target HRTF in the J second target HRTFs is a j^{th} channel signal in the J channel signals, the audio rendering apparatus convolves the j^{th} second target HRTF with the j^{th} channel signal, to obtain a rendered signal of the j^{th} channel signal.

In this case, a low frequency band HRTF (that is, the first HRTF or the third HRTF) and a high frequency band HRTF (that is, the second HRTF or the fourth HRTF) may be obtained by performing high-pass and low-pass filtering by using a binaural HRTF that uses the position of the center of the head of the listener as a sweet spot. In this way, accuracy of an ITD of an obtained binaural rendered signal is high after the low frequency band HRTF acts on the to-be-rendered audio signal, and accuracy of an ILD of the obtained binaural rendered signal is high after the high frequency band HRTF acts on the to-be-rendered audio signal. In this way, the high-accuracy ITD and ILD improve accuracy of sound image localization performed based on the binaural rendered signal, reduce in-head effect of the binaural rendered signal, and increase a sound field width of the binaural rendered signal.

The foregoing mainly describes the solutions provided in embodiments of this application from the perspective of the methods. Corresponding hardware structures and/or software modules for performing the functions are included, to implement the foregoing functions. A person skilled in the art should be easily aware that, in combination with units and algorithm operations of the examples described in embodiments disclosed in this specification, this application can be implemented by hardware or a combination of hardware and computer software. Whether a specific function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the audio rendering apparatus may be divided into functional modules based on the foregoing method examples. For example, each functional module may be obtained through division based on a corresponding function, or two or more functions may be integrated into one processing module. The integrated module may be implemented in a form of hardware, or may be implemented in a form of a software functional module. It should be noted that, in this embodiment of this application, division into the modules is an example, and is merely logical function division. During actual implementation, another division manner may be used.

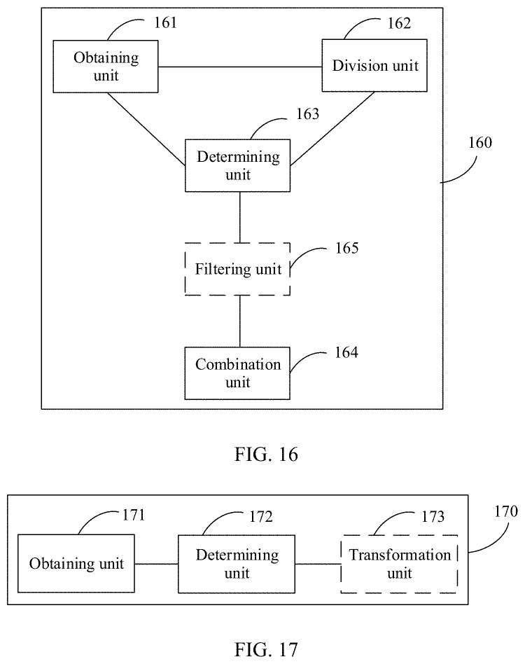

FIG. 16 is a schematic diagram of a structure of an audio rendering apparatus 160 according to an embodiment of this application. The audio rendering apparatus 160 may be configured to perform the foregoing audio rendering method, for example, configured to perform the method shown in FIG. 3, FIG. 9, or FIG. 10. The audio rendering apparatus 160 may include an obtaining unit 161, a division unit 162, a determining unit 163, and a combination unit 164.

The obtaining unit 161 is configured to obtain a to-be-rendered audio signal. The division unit 162 is configured to divide the to-be-rendered audio signal into a high frequency band signal and a low frequency band signal. The determining unit 163 is configured to: determine, by using a first position as a sweet spot, a first rendered signal corresponding to the high frequency band signal; determine, by using a second position as a sweet spot, a second rendered signal corresponding to the high frequency band signal. The second position is the position of the right ear of a listener when the first position is the position of the left ear of the listener, or the second position is the position of the left ear of the listener when the first position is the position of the right ear of the listener. The determining unit 163 is further configured to determine, by using the position of the center of the head of the listener as a sweet spot, a third rendered signal and a fourth rendered signal that correspond to the low frequency band signal. The third rendered signal is used to determine a rendered signal output to the first position, and the fourth rendered signal is used to determine a rendered signal output to the second position. The combination unit 164 is configured to: combine the first rendered signal and the third rendered signal to obtain a first target rendered signal, and combine the second rendered signal and the fourth rendered signal to obtain a second target rendered signal. The first target rendered signal is a rendered signal output to the first position, and the second target rendered signal is a rendered signal output to the second position.

For example, with reference to FIG. 3, the obtaining unit 161 may be configured to perform S101, the division unit 162 may be configured to perform S102, the determining unit 163 may be configured to perform S103 and S104, and the combination unit 164 may be configured to perform S106.

Optionally, the combination unit 164 is configured to: separately perform fade-in processing on a signal in a transition band of the first rendered signal and a signal in a transition band of the second rendered signal, and separately perform fade-out processing on a signal in a transition band of the third rendered signal and a signal in a transition band of the fourth rendered signal, where the transition band is a frequency band with a frequency range between a critical frequency between the high frequency band signal and the low frequency band signal minus a second bandwidth, and the critical frequency plus a first bandwidth; obtain a first combined signal based on a fade-in processed first rendered signal and a fade-out processed third rendered signal, and obtain a second combined signal based on a fade-in processed second rendered signal and a fade-out processed fourth rendered signal; and combine the first combined signal, a signal beyond the transition band of the first rendered signal, and a signal beyond the transition band of the third rendered signal to obtain the first target rendered signal; and combine the second combined signal, a signal beyond the transition band of the second rendered signal, and a signal beyond the transition band of the fourth rendered signal to obtain the second target rendered signal.

For example, with reference to FIG. 3, the combination unit 164 may be configured to perform S106.

Optionally, the combination unit 164 is configured to: separately perform fade-in processing on the signal in the transition band of the first rendered signal and the signal in the transition band of the second rendered signal by using a fade-in factor, and separately perform fade-out processing on the signal in the transition band of the third rendered signal and the signal in the transition band of the fourth rendered signal by using a fade-out factor. The transition band corresponds to T combinations of a fade-in factor and a fade-out factor, where T is a positive integer, and a sum of a fade-in factor and a fade-out factor that correspond to any one of the T combinations is 1.

For example, with reference to FIG. 3, the combination unit 164 may be configured to perform S106.

Optionally, the audio rendering apparatus 160 further includes: a filtering unit 165, configured to: before the combination unit 164 “combines the first rendered signal and the third rendered signal to obtain the first target rendered signal, and combines the second rendered signal and the fourth rendered signal to obtain the second target rendered signal”, perform group delay filtering processing on the first rendered signal or the third rendered signal, so that a group delay of a first rendered signal obtained through group delay filtering processing or a third rendered signal obtained through group delay filtering processing is a fixed value; and perform group delay filtering processing on the second rendered signal or the fourth rendered signal, so that a group delay of a second rendered signal obtained through group delay filtering processing or a fourth rendered signal obtained through group delay filtering processing is a fixed value. The combination unit 164 is configured to: combine a rendered signal obtained through group delay filtering processing and a rendered signal that does not undergo group delay filtering processing, to obtain the first target rendered signal, where the rendered signal obtained through group delay filtering processing and the rendered signal that does not undergo group delay filtering processing are in the first rendered signal and the third rendered signal; and combine a rendered signal obtained through group delay filtering processing and a rendered signal that does not undergo group delay filtering processing, to obtain the second target rendered signal, where the rendered signal obtained through group delay filtering processing and the rendered signal that does not undergo group delay filtering processing are in the second rendered signal and the fourth rendered signal.

For example, with reference to FIG. 3, the filtering unit 165 may be configured to perform S105, and the combination unit 164 may be configured to perform S106.

Optionally, the obtaining unit 161 is further configured to:

obtain, by using the first position as the sweet spot, M first signals corresponding to the high frequency band signal, where the M first signals are signals of M virtual speakers, and the M first signals one-to-one correspond to the M virtual speakers, where M is a positive integer;

obtain, by using the second position as the sweet spot, N second signals corresponding to the high frequency band signal, where the N second signals are signals of N virtual speakers, and the N second signals one-to-one correspond to the N virtual speakers, where N is a positive integer, and N=M;

obtain M first head-related transfer functions (HRTFS) and N second HRTFs, where the M first HRTFs one-to-one correspond to the M first signals, and the N second HRTFs one-to-one correspond to the N second signals.

The determining unit 163 is configured to: determine the first rendered signal based on the M first signals and the M first HRTFs, and determine the second rendered signal based on the N second signals and the N second HRTFs.

For example, with reference to FIG. 9, the obtaining unit 161 may be configured to perform S1031, S1032, and S1033.

Optionally, the obtaining unit 161 is configured to: process the high frequency band signal to obtain the M first signals of the M virtual speakers, where the M virtual speakers are M virtual speakers disposed by using the first position as the sweet spot; and process the high frequency band signal to obtain the N second signals of the N virtual speakers, where the N virtual speakers are N virtual speakers disposed by using the second position as the sweet spot.

For example, with reference to FIG. 9, the obtaining unit 161 may be configured to perform S1031.

Optionally, the obtaining unit 161 is further configured to process the high frequency band signal to obtain X initial signals corresponding to X virtual speakers. The X initial signals one-to-one correspond to the X virtual speakers, and the X virtual speakers are X virtual speakers disposed by using the position of the center of the head as the sweet spot, where X is a positive integer, and X=M=N.

The obtaining unit 161 is configured to:

separately rotate the X initial signals by a first angle to obtain the M first signals, where the first angle is an included angle between a first connection line and a second connection line, the first connection line is a connection line between a position of a first virtual speaker and the position of the center of the head, the second connection line is a connection line between the position of the first virtual speaker and the first position, and the first virtual speaker is any one of the X virtual speakers; and separately rotate the X initial signals by a second angle to obtain the N second signals, where the second angle is an included angle between the first connection line and a third connection line, and the third connection line is a connection line between the position of the first virtual speaker and the second position.

For example, with reference to FIG. 9, the obtaining unit 161 may be configured to perform S1031.

Optionally, the M first HRTFs are HRTFs of the first position that are measured based on the M first signals by using the first position as the sweet spot, and the N second HRTFs are HRTFs of the second position that are measured based on the N second signals by using the second position as the sweet spot.

Optionally, the obtaining unit 161 is configured to:

obtain Y initial HRTFs, where the Y initial HRTFs are HRTFs of the position of the center of the head that are measured based on signals of Y virtual speakers by using the position of the center of the head as a sweet spot, the Y virtual speakers are Y virtual speakers that are disposed by using the position of the center of the head as the sweet spot, and the Y initial HRTFs one-to-one correspond to the signals of the Y virtual speakers, where Y is a positive integer, and Y=M=N;

separately rotate the Y initial HRTFs by a third angle, to obtain the M first HRTFs, where the third angle is an included angle between the third connection line and a fourth connection line, the third connection line is a connection line between a position of a second virtual speaker and the position of the center of the head, the fourth connection line is a connection line between the position of the second virtual speaker and the first position, and the second virtual speaker is any one of the Y virtual speakers; and

separately rotate the Y initial HRTFs by a fourth angle to obtain the N second HRTFs, where the fourth angle is an included angle between the third connection line and a fifth connection line, and the fifth connection line is a connection line between the position of the second virtual speaker and the second position.

For example, with reference to FIG. 9, the obtaining unit 161 may be configured to perform S1032.

Optionally, the obtaining unit 161 is further configured to:

process the low frequency band signal to obtain R third signals, where the R third signals are signals of R virtual speakers, the R third signals one-to-one correspond to the R virtual speakers, and the R virtual speakers are R virtual speakers disposed by using the position of the center of the head as the sweet spot, where R is a positive integer;

obtain R third HRTFs, where the R third HRTFs are HRTFs of the first position that are measured based on the R third signals by using the position of the center of the head as the sweet spot, and the R third HRTFs one-to-one correspond to the R third signals; and

obtain R fourth HRTFs, where the R fourth HRTFs are HRTFs of the second position that are measured based on the R third signals by using the position of the center of the head as the sweet spot, and the R fourth HRTFs one-to-one correspond to the R third signals; and

The determining unit 163 is configured to: determine the third rendered signal based on the R third signals and the R third HRTFs, and determine the fourth rendered signal based on the R fourth signals and the R fourth HRTFs.

For example, with reference to FIG. 10, the obtaining unit 161 may be configured to perform S1041, S1042, and S1043.

Optionally, the obtaining unit 161 is configured to: receive the to-be-rendered audio signal obtained by an audio decoder through decoding, receive the to-be-rendered audio signal collected by an audio collector, or obtain the to-be-rendered audio signal obtained by performing synthesis processing on a plurality of audio signals.

For example, with reference to FIG. 3, the obtaining unit 161 may be configured to perform S101.

For specific descriptions of the foregoing optional manners, refer to the foregoing method embodiments. Details are not described herein again. In addition, for descriptions of both explanations and beneficial effects of the audio rendering apparatus 160 provided above, refer to the foregoing corresponding method embodiments. Details are not described again.

For example, with reference to FIG. 2, the obtaining unit 161, the division unit 162, determining unit 163, the combination unit 164, and the filtering unit 165 in the audio rendering apparatus 160 may be implemented by the processor 21 in FIG. 2 by executing the program code in the memory 22 in FIG. 2.

FIG. 17 is a schematic diagram of a structure of an audio rendering apparatus 170 according to an embodiment of this application. The audio rendering apparatus 170 may be configured to perform the foregoing audio rendering method, for example, the method shown in FIG. 13. The audio rendering apparatus 170 may include an obtaining unit 171 and a determining unit 172.

The obtaining unit 171 is configured to obtain a to-be-rendered audio signal. The determining unit 172 is configured to determine K first combined HRTFs based on K first head-related transfer functions (HRTFS) and K second HRTFs. The K first combined HRTFs are left-ear HRTFs for processing the to-be-rendered audio signal, the K first HRTFs are left-ear HRTFs for processing a low frequency band signal in the to-be-rendered audio signal, and the K second HRTFs are left-ear HRTFs for processing a high frequency band signal in the to-be-rendered audio signal, where K is a positive integer. The determining unit 172 is further configured to determine K second combined HRTFs based on K third HRTFs and K fourth HRTFs. The K second combined HRTFs are right-ear HRTFs for processing the to-be-rendered audio signal, the K third HRTFs are right-ear HRTFs for processing the low frequency band signal in the to-be-rendered audio signal, and the K fourth HRTFs are right-ear HRTFs for processing the high frequency band signal in the to-be-rendered audio signal. The determining unit 172 is further configured to: determine a first target rendered signal based on the K first combined HRTFs and the to-be-rendered audio signal, where the first target rendered signal is a rendered signal output to the left ear of a listener; and determine a second target rendered signal based on the K second combined HRTFs and the to-be-rendered audio signal, where the second target rendered signal is a rendered signal output to the right ear of the listener.

For example, with reference to FIG. 13, the obtaining unit 171 may be configured to perform S201, and the determining unit 172 may be configured to perform S204 and S206.

Optionally, the first HRTF and the second HRTF are determined based on a same left-ear HRTF, and the third HRTF and the fourth HRTF are determined based on a same right-ear HRTF.

Optionally, the obtaining unit 171 is further configured to obtain K left-ear initial HRTFs before the determining unit 172 determines the K first combined HRTFs based on the K first HRTFs and the K second HRTFs. The K left-ear initial HRTFs are left-ear HRTFs measured based on signals of K virtual speakers by using the position of the center of the head of the listener as a sweet spot, and the K left-ear initial HRTFs one-to-one correspond to the signals of the K virtual speakers. The obtaining unit 171 is further configured to obtain K right-ear initial HRTFs before the determining unit 172 determines the K second combined HRTFs based on the K third HRTFs and the K fourth HRTFs. The K right-ear initial HRTFs are right-ear HRTFs measured based on the signals of the K virtual speakers by using the position of the center of the head of the listener as the sweet spot, and the K right-ear initial HRTFs one-to-one correspond to the signals of the K virtual speakers. The K virtual speakers are K virtual speakers disposed by using the position of the center of the head of the listener as the sweet spot. The determining unit 172 is further configured to: determine the K first HRTFs and the K second HRTFs based on the K left-ear initial HRTFs, and determine the K third HRTFs and the K fourth HRTFs based on the K right-ear initial HRTFs.

For example, with reference to FIG. 13, the obtaining unit 171 may be configured to perform S202, and the determining unit 172 may be configured to perform S203.

Optionally, the determining unit 172 is configured to:

perform low-pass filtering processing on the K left-ear initial HRTFs to obtain the K first HRTFs; perform high-pass filtering processing on the K left-ear initial HRTFs to obtain the K second HRTFs; perform low-pass filtering processing on the K right-ear initial HRTFs to obtain the K third HRTFs; and perform high-pass filtering processing on the K right-ear initial HRTFs to obtain the K fourth HRTFs.

For example, with reference to FIG. 13, the determining unit 172 may be configured to perform S203.

Optionally, the determining unit 172 is configured to:

perform low-pass filtering processing and delay processing on the K left-ear initial HRTFs to obtain the K first HRTFs, and perform high-pass filtering processing on the K left-ear initial HRTFs to obtain the K second HRTFs; or perform low-pass filtering processing on the K left-ear initial HRTFs to obtain the K first HRTFs, and perform high-pass filtering processing and delay processing on the K left-ear initial HRTFs to obtain the K second HRTFs; and

perform low-pass filtering processing and delay processing on the K right-ear initial HRTFs to obtain the K third HRTFs, and perform high-pass filtering processing on the K right-ear initial HRTFs to obtain the K fourth HRTFs; or perform low-pass filtering processing on the K right-ear initial HRTFs to obtain the K third HRTFs, and perform high-pass filtering processing and delay processing on the K right-ear initial HRTFs to obtain the K fourth HRTFs.

For example, with reference to FIG. 13, the determining unit 172 may be configured to perform S203.

Optionally, the to-be-rendered audio signal includes J channel signals, where J is a positive integer. The audio rendering apparatus 170 further includes a transformation unit 173. The transformation unit 173 is configured to transform the K first combined HRTFs into a to-be-rendered audio signal domain to obtain J first target HRTFs. The J first target HRTFs are left-ear HRTFs in the to-be-rendered audio signal domain, and the J first target HRTFs one-to-one correspond to the J channel signals. The transformation unit 173 is further configured to transform the K second combined HRTFs into the to-be-rendered audio signal domain to obtain J second target HRTFs. The J second target HRTFs are right-ear HRTFs in the to-be-rendered audio signal domain, and the J second target HRTFs one-to-one correspond to the J channel signals. The determining unit 172 is configured to: determine the first target rendered signal based on the J first target HRTFs and the J channel signals, and determine the second target rendered signal based on the J second target HRTFs and the J channel signals.

For example, with reference to FIG. 13, the transformation unit 173 may be configured to perform S205.

Optionally, the determining unit 172 is configured to: convolve each of the J first target HRTFs with a corresponding channel signal in the J channel signals to obtain the first target rendered signal; and convolve each of the J second target HRTFs with a corresponding channel signal in the J channel signals to obtain the second target rendered signal.

For example, with reference to FIG. 13, the determining unit 172 may be configured to perform S206.

Optionally, the obtaining unit 171 is configured to: receive the to-be-rendered audio signal obtained by an audio decoder through decoding, receive the to-be-rendered audio signal collected by an audio collector, or obtain the to-be-rendered audio signal obtained by performing synthesis processing on a plurality of audio signals.

For example, with reference to FIG. 13, the obtaining unit 171 may be configured to perform S201.

For specific descriptions of the foregoing optional manners, refer to the foregoing method embodiments. Details are not described herein again. In addition, for descriptions of both explanations and beneficial effects of the audio rendering apparatus 170 provided above, refer to the foregoing corresponding method embodiments. Details are not described again.

For example, with reference to FIG. 2, the obtaining unit 171, the determining unit 172, and the transformation unit 173 in the audio rendering apparatus 170 may be implemented by the processor 21 in FIG. 2 by executing the program code in the memory 22 in FIG. 2.

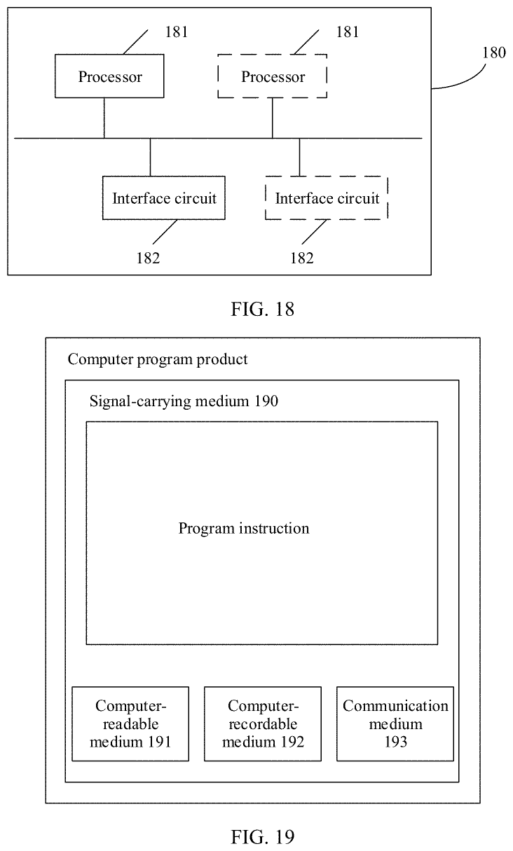

An embodiment of this application further provides a chip system 180. As shown in FIG. 18, the chip system 180 includes at least one processor 181 and at least one interface circuit 182. The processor 181 and the interface circuit 182 may be interconnected through a line. For example, the interface circuit 182 may be configured to receive a signal (for example, obtain a to-be-rendered audio signal). For another example, the interface circuit 182 may be configured to send a signal to another apparatus (for example, the processor 181). For example, the interface circuit 182 may read instructions stored in a memory, and send the instructions to the processor 181. When the instructions are executed by the processor 181, the audio rendering apparatus may be enabled to perform the operations in the foregoing embodiments. Certainly, the chip system 180 may further include another discrete device. This is not limited in this embodiment of this application.

Another embodiment of this application further provides a computer-readable storage medium. The computer-readable storage medium stores instructions. When the instructions are run on an audio rendering apparatus, the audio rendering apparatus performs the operations performed by the audio rendering apparatus in the procedures of the methods shown in the foregoing method embodiments.

In some embodiments, the disclosed methods may be implemented as computer program instructions encoded in a machine-readable format on a computer-readable storage medium or encoded on another non-transitory medium or product.

FIG. 19 schematically shows a conceptual partial view of a computer program product according to an embodiment of this application. The computer program product includes a computer program used to execute a computer process on a computing device.

In an embodiment, the computer program product is provided by using a signal-carrying medium 190. The signal-carrying medium 190 may include one or more program instructions. When the one or more program instructions are run by one or more processors, the functions or a part of the functions described in FIG. 3 or FIG. 13 may be provided. Therefore, for example, one or more features in S101 to S106 in FIG. 3 or S201 to S206 in FIG. 13 may be carried by one or more instructions associated with the signal-carrying medium 190. In addition, the program instructions in FIG. 19 are also described as example instructions.

In some examples, the signal-carrying medium 190 may include a computer-readable medium 191, for example, but not limited to, a hard disk drive, a compact disc (CD), a digital video disc (DVD), a digital tape, a memory, a read-only memory (ROM), or a random access memory (RAM).

In some implementations, the signal-carrying medium 190 may include a computer-recordable medium 192, for example, but not limited to, a memory, a read/write (R/W) CD, or an R/W DVD.

In some implementations, the signal-carrying medium 190 may include a communication medium 193, for example, but not limited to, a digital and/or analog communication medium (for example, an optical fiber cable, a waveguide, a wired communication link, or a wireless communication link).

The signal-carrying medium 190 may be conveyed by a communication medium 193 in a wireless form (for example, a wireless communication medium that complies with the IEEE 1902.11 standard or another transmission protocol). The one or more program instructions may be, for example, one or more computer-executable instructions or one or more logic implementation instructions.

In some examples, the audio rendering apparatus described with respect to FIG. 3 or FIG. 13 may be configured to provide various operations, functions, or actions in response to one or more program instructions in the computer-readable medium 191, the computer-recordable medium 192, and/or the communication medium 193.

It should be understood that the arrangement described herein is merely used as an example. Thus, a person skilled in the art appreciate that another arrangement and another element (for example, a machine, an interface, a function, a sequence, and an array of functions) can be used to replace the arrangement, and some elements may be omitted together depending on a desired result. In addition, many of the described elements are functional entities that can be implemented as discrete or distributed components, or implemented in any suitable combination at any suitable position in combination with another component.

All or a part of the foregoing embodiments may be implemented by using software, hardware, firmware, or any combination thereof. When a software program is used to implement embodiments, embodiments may be implemented completely or partially in a form of a computer program product. The computer program product includes one or more computer instructions. When the computer-executable instructions are executed on a computer, the procedures or functions according to the embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An audio rendering method, comprising:
obtaining a to-be-rendered audio signal, wherein the to-be-rendered audio signal include a low frequency signal and high frequency signal separated by a preset critical frequency;
determining K first combined head-related transfer functions (HRTFs) based on K first HRTFs and K second HRTFs, wherein the K first combined HRTFs are left-ear HRTFs for processing the to-be-rendered audio signal, the K first HRTFs are left-ear HRTFs for processing the low frequency band signal in the to-be-rendered audio signal, and the K second HRTFs are left-ear HRTFs for processing the high frequency band signal in the to-be-rendered audio signal, wherein K is a positive integer;
determining K second combined HRTFs based on K third HRTFs and K fourth HRTFs, wherein the K second combined HRTFs are right-ear HRTFs for processing the to-be-rendered audio signal, the K third HRTFs are right-ear HRTFs for processing the low frequency band signal in the to-be-rendered audio signal, and the K fourth HRTFs are right-ear HRTFs for processing the high frequency band signal in the to-be-rendered audio signal; and
determining a first target rendered signal based on the K first combined HRTFs and the to-be-rendered audio signal, wherein the first target rendered signal is a rendered signal output to a left ear of a listener; and
determining a second target rendered signal based on the K second combined HRTFs and the to-be-rendered audio signal, wherein the second target rendered signal is a rendered signal output to a right ear of the listener.

2. The method according to claim 1, wherein
the first HRTF and the second HRTF are determined based on a same left-ear HRTF; and
the third HRTF and the fourth HRTF are determined based on a same right-ear HRTF.

3. The method according to claim 1, further comprising:
before the determining the K first combined HRTFs based on the K first HRTFs and the K second HRTFs, obtaining K left-ear initial HRTFs, wherein the K left-ear initial HRTFs are left-ear HRTFs measured based on signals of K virtual speakers by using a position of a center of a head of the listener as a sweet spot, and the K left-ear initial HRTFs one-to-one correspond to the signals of the K virtual speakers, and determining the K first HRTFs and the K second HRTFs based on the K left-ear initial HRTFs; and
before the determining the K second combined HRTFs based on the K third HRTFs and the K fourth HRTFs, obtaining K right-ear initial HRTFs, wherein the K right-ear initial HRTFs are right-ear HRTFs measured based on the signals of the K virtual speakers by using the position of the center of the head of the listener as the sweet spot, and the K right-ear initial HRTFs one-to-one correspond to the signals of the K virtual speakers, and determining the K third HRTFs and the K fourth HRTFs based on the K right-ear initial HRTFs;
wherein the K virtual speakers are disposed by using the position of the center of the head of the listener as the sweet spot.

4. The method according to claim 3, wherein
the determining the K first HRTFs and the K second HRTFs based on the K left-ear initial HRTFs comprises:
performing low-pass filtering processing or a combination of the low-pass filtering processing and delay processing on the K left-ear initial HRTFs to obtain the K first HRTFs; and
performing high-pass filtering processing or a combination of the high-pass filtering processing and the delayed processing on the K left-ear initial HRTFs to obtain the K second HRTFs; and
wherein the determining the K third HRTFs and the K fourth HRTFs based on the K right-ear initial HRTFs comprises:
performing the low-pass filtering processing or a combination of the low-pass filtering processing and the delayed processing on the K right-ear initial HRTFs to obtain the K third HRTFs; and
performing the high-pass filtering processing or a combination of the high-pass filtering and the delayed processing on the K right-ear initial HRTFs to obtain the K fourth HRTFs.

5. The method according to claim 1, wherein the to-be-rendered audio signal comprises J channel signals, wherein J is a positive integer; and
the determining the first target rendered signal based on the K first combined HRTFs and the to-be-rendered audio signal comprises:
transforming the K first combined HRTFs into a to-be-rendered audio signal domain to obtain J first target HRTFs, wherein the J first target HRTFs are left-ear HRTFs in the domain, and the J first target HRTFs one-to-one correspond to the J channel signals; and
determining the first target rendered signal based on the J first target HRTFs and the J channel signals; and
the determining the second target rendered signal based on the K second combined HRTFs and the to-be-rendered audio signal comprises:
transforming the K second combined HRTFs into the domain to obtain J second target HRTFs, wherein the J second target HRTFs are right-ear HRTFs in the domain, and the J second target HRTFs one-to-one correspond to the J channel signals; and
determining the second target rendered signal based on the J second target HRTFs and the J channel signals.

6. The method according to claim 5, wherein
the determining the first target rendered signal based on the J first target HRTFs and the J channel signals comprises:
convolving each of the J first target HRTFs with a corresponding channel signal in the J channel signals to obtain the first target rendered signal; and
the determining the second target rendered signal based on the J second target HRTFs and the J channel signals comprises: convolving each of the J second target HRTFs with a corresponding channel signal in the J channel signals to obtain the second target rendered signal.

7. The method according to claim 1, wherein the obtaining the to-be-rendered audio signal comprises:
receiving the to-be-rendered audio signal obtained by an audio decoder through decoding, receiving the to-be-rendered audio signal collected by an audio collector, or obtaining the to-be-rendered audio signal obtained by performing synthesis processing on a plurality of audio signals.

8. An apparatus, comprising:
at least one processor; and
one or more memories coupled to the at least one processor and storing program instructions for execution by the at least one processor to cause the apparatus to perform operations comprising:
obtaining a to-be-rendered audio signal, wherein the to-be-rendered audio signal include a low frequency signal and high frequency signal separated by a preset critical frequency;
determining K first combined head-related transfer functions (HRTFs) based on K first HRTFs and K second HRTFs, wherein the K first combined HRTFs are left-ear HRTFs for processing the to-be-rendered audio signal, the K first HRTFs are left-ear HRTFs for processing the low frequency band signal in the to-be-rendered audio signal, and the K second HRTFs are left-ear HRTFs for processing the high frequency band signal in the to-be-rendered audio signal, wherein K is a positive integer;
determining K second combined HRTFs based on K third HRTFs and K fourth HRTFs, wherein the K second combined HRTFs are right-ear HRTFs for processing the to-be-rendered audio signal, the K third HRTFs are right-ear HRTFs for processing the low frequency band signal in the to-be-rendered audio signal, and the K fourth HRTFs are right-ear HRTFs for processing the high frequency band signal in the to-be-rendered audio signal; and
determining a first target rendered signal based on the K first combined HRTFs and the to-be-rendered audio signal, wherein the first target rendered signal is a rendered signal output to a left ear of a listener; and determining a second target rendered signal based on the K second combined HRTFs and the to-be-rendered audio signal, wherein the second target rendered signal is a rendered signal output to a right ear of the listener.

9. The apparatus according to claim 8, wherein
the first HRTF and the second HRTF are determined based on a same left-ear HRTF; and
the third HRTF and the fourth HRTF are determined based on a same right-ear HRTF.

10. The apparatus according to claim 8, wherein the operations further comprise:
before the determining the K first combined HRTFs based on K first HRTFs and the K second HRTFs, obtaining K left-ear initial HRTFs, wherein the K left-ear initial HRTFs are left-ear HRTFs measured based on signals of K virtual speakers by using a position of a center of a head of the listener as a sweet spot, and the K left-ear initial HRTFs one-to-one correspond to the signals of the K virtual speakers, and determining the K first HRTFs and the K second HRTFs based on the K left-ear initial HRTFs; and
before the determining the K second combined HRTFs based on the K third HRTFs and the K fourth HRTFs, obtaining K right-ear initial HRTFs, wherein the K right-ear initial HRTFs are right-ear HRTFs measured based on the signals of the K virtual speakers by using the position of the center of the head of the listener as the sweet spot, and the K right-ear initial HRTFs one-to-one correspond to the signals of the K virtual speakers, and determining the K third HRTFs and the K fourth HRTFs based on the K right-ear initial HRTFs;
wherein the K virtual speakers are disposed by using the position of the center of the head of the listener as the sweet spot.

11. The apparatus according to claim 10, wherein the operations further comprise:
performing low-pass filtering processing or a combination of the low-pass filtering processing and delay processing on the K left-ear initial HRTFs to obtain the K first HRTFs; and
performing high-pass filtering processing or a combination of the high-pass filtering processing and the delayed processing on the K left-ear initial HRTFs to obtain the K second HRTFs; and
wherein the determining the K third HRTFs and the K fourth HRTFs based on the K right-ear initial HRTFs comprises:
performing the low-pass filtering processing or a combination of the low-pass filtering processing and the delayed processing on the K right-ear initial HRTFs to obtain the K third HRTFs; and
performing the high-pass filtering processing or a combination of the high-pass filtering and the delayed processing on the K right-ear initial HRTFs to obtain the K fourth HRTFs.

12. The apparatus according to claim 8, wherein the to-be-rendered audio signal comprises J channel signals, wherein J is a positive integer; and
the determining the first target rendered signal based on the K first combined HRTFs and the to-be-rendered audio signal comprises:
transforming the K first combined HRTFs into a to-be-rendered audio signal domain to obtain J first target HRTFs, wherein the J first target HRTFs are left-ear HRTFs in the domain, and the J first target HRTFs one-to-one correspond to the J channel signals; and
determining the first target rendered signal based on the J first target HRTFs and the J channel signals; and
the determining the second target rendered signal based on the K second combined HRTFs and the to-be-rendered audio signal comprises:
transforming the K second combined HRTFs into the domain to obtain J second target HRTFs, wherein the J second target HRTFs are right-ear HRTFs in the domain, and the J second target HRTFs one-to-one correspond to the J channel signals; and
determining the second target rendered signal based on the J second target HRTFs and the J channel signals.

13. The apparatus according to claim 12, wherein the operations further comprise:
the determining the first target rendered signal based on the J first target HRTFs and the J channel signals comprises:
convolving each of the J first target HRTFs with a corresponding channel signal in the J channel signals to obtain the first target rendered signal; and
the determining the second target rendered signal based on the J second target HRTFs and the J channel signals comprises: convolving each of the J second target HRTFs with a corresponding channel signal in the J channel signals to obtain the second target rendered signal.

14. The apparatus according to claim 8, wherein the operations further comprise:
receiving the to-be-rendered audio signal obtained by decoding, receive the to-be-rendered audio signal collected by an audio collector, or obtain the to-be-rendered audio signal obtained by performing synthesis processing on a plurality of audio signals.

15. A non-transitory computer-readable storage medium storing computer instructions, that when executed by one or more processors, cause the one or more processors to perform the operations comprising:
obtaining a to-be-rendered audio signal, wherein the to-be-rendered audio signal include a low frequency signal and high frequency signal separated by a preset critical frequency;
determining K first combined head-related transfer functions (HRTFs) based on K first HRTFs and K second HRTFs, wherein the K first combined HRTFs are left-ear HRTFs for processing the to-be-rendered audio signal, the K first HRTFs are left-ear HRTFs for processing the low frequency band signal in the to-be-rendered audio signal, and the K second HRTFs are left-ear HRTFs for processing the high frequency band signal in the to-be-rendered audio signal, wherein K is a positive integer;
determining K second combined HRTFs based on K third HRTFs and K fourth HRTFs, wherein the K second combined HRTFs are right-ear HRTFs for processing the to-be-rendered audio signal, the K third HRTFs are right-ear HRTFs for processing the low frequency band signal in the to-be-rendered audio signal, and the K fourth HRTFs are right-ear HRTFs for processing the high frequency band signal in the to-be-rendered audio signal; and
determining a first target rendered signal based on the K first combined HRTFs and the to-be-rendered audio signal, wherein the first target rendered signal is a rendered signal output to a left ear of a listener; and determining a second target rendered signal based on the K second combined HRTFs and the to-be-rendered audio signal, wherein the second target rendered signal is a rendered signal output to a right ear of the listener.

16. The non-transitory computer-readable storage medium according to claim 15, wherein
the first HRTF and the second HRTF are determined based on a same left-ear HRTF; and
the third HRTF and the fourth HRTF are determined based on a same right-ear HRTF.

17. The non-transitory computer-readable storage medium according to claim 15, wherein the operations further comprise:
before the determining K first combined HRTFs based on K first HRTFs and K second HRTFs, obtaining K left-ear initial HRTFs, wherein the K left-ear initial HRTFs are left-ear HRTFs measured based on signals of K virtual speakers by using a position of a center of a head of the listener as a sweet spot, and the K left-ear initial HRTFs one-to-one correspond to the signals of the K virtual speakers, and determining the K first HRTFs and the K second HRTFs based on the K left-ear initial HRTFs; and
before the determining K second combined HRTFs based on the K third HRTFs and the K fourth HRTFs, obtaining K right-ear initial HRTFs, wherein the K right-ear initial HRTFs are right-ear HRTFs measured based on the signals of the K virtual speakers by using the position of the center of the head of the listener as the sweet spot, and the K right-ear initial HRTFs one-to-one correspond to the signals of the K virtual speakers, and determining the K third HRTFs and the K fourth HRTFs based on the K right-ear initial HRTFs;
wherein the K virtual speakers are disposed by using the position of the center of the head of the listener as the sweet spot.

18. The non-transitory computer-readable storage medium according to claim 17, wherein the operations further comprise:
performing low-pass filtering processing or a combination of the low-pass filtering processing and delay processing on the K left-ear initial HRTFs to obtain the K first HRTFs; and
performing high-pass filtering processing or a combination of the high-pass filtering processing and the delayed processing on the K left-ear initial HRTFs to obtain the K second HRTFs; and
wherein the determining the K third HRTFs and the K fourth HRTFs based on the K right-ear initial HRTFs comprises:
performing the low-pass filtering processing or a combination of the low-pass filtering processing and the delayed processing on the K right-ear initial HRTFs to obtain the K third HRTFs; and
performing the high-pass filtering processing or a combination of the high-pass filtering and the delayed processing on the K right-ear initial HRTFs to obtain the K fourth HRTFs.

19. The non-transitory computer-readable storage medium according to claim 15, wherein the to-be-rendered audio signal comprises J channel signals, wherein J is a positive integer; and
the determining the first target rendered signal based on the K first combined HRTFs and the to-be-rendered audio signal comprises:
transforming the K first combined HRTFs into a to-be-rendered audio signal domain to obtain J first target HRTFs, wherein the J first target HRTFs are left-ear HRTFs in the domain, and the J first target HRTFs one-to-one correspond to the J channel signals; and
determining the first target rendered signal based on the J first target HRTFs and the J channel signals; and
the determining the second target rendered signal based on the K second combined HRTFs and the to-be-rendered audio signal comprises:
transforming the K second combined HRTFs into the domain to obtain J second target HRTFs, wherein the J second target HRTFs are right-ear HRTFs in the domain, and the J second target HRTFs one-to-one correspond to the J channel signals; and
determining the second target rendered signal based on the J second target HRTFs and the J channel signals.

20. The non-transitory computer-readable storage medium according to claim 19, wherein
the determining the first target rendered signal based on the J first target HRTFs and the J channel signals comprises: convolving each of the J first target HRTFs with a corresponding channel signal in the J channel signals to obtain the first target rendered signal; and
the determining the second target rendered signal based on the J second target HRTFs and the J channel signals comprises: convolving each of the J second target HRTFs with a corresponding channel signal in the J channel signals to obtain the second target rendered signal.
